(19) United States
(12) Patent Application Publication
(10) Pub. No.: US 2024/0400222 A1
(43) Pub. Date: Dec. 5, 2024

(54) SYSTEMS AND METHODS FOR CONTROL MARGIN DISPLAY FOR EVTOL AIRCRAFT

(71) Applicant: Archer Aviation Inc., San Jose, CA (US)

(72) Inventors: Nansi XUE, Redondo Beach, CA (US); Nathan Thomas DEPENBUSCH, Mountain View, CA (US)

(73) Assignee: Archer Aviation Inc., San Jose, CA (US)

(21) Appl. No.: 18/669,668

(22) Filed: May 21, 2024

Related U.S. Application Data
(60) Provisional application No. 63/504,958, filed on May 30, 2023.

(51) Int. Cl. B64D 45/00; G01C 23/00

(52) U.S. Cl. CPC B64D 45/00; G01C 23/005

(57) ABSTRACT

Aspects of this present disclosure relate to systems and methods for dynamically moving graphical elements of a user interface of a flight control system. In one, a method is disclosed comprising: determining aircraft authority limits based on at least one state signal indicating an aircraft state, wherein the aircraft authority limits indicate an extent to which one or more control signals can command the aircraft; determining one or more proximities between the aircraft state and the determined aircraft authority limits; and automatically moving the graphical elements of the user interface to one or more positions on the user interface based on the determined one or more proximities.

### CROSS-REFERENCE TO RELATED APPLICATIONS

This disclosure claims priority to U.S. Provisional Application No. 63/504,958, titled “SYSTEMS AND METHODS FOR FLIGHT CONTROL OF EVTOL AIRCRAFT,” filed May 30, 2023 (Attorney Docket No. 16499.6005-00000), the contents of which are incorporated by reference herein in their entirety for all purposes.

### TECHNICAL FIELD

This disclosure relates generally to powered aerial vehicles. More particularly, and without limitation, the present disclosure relates to innovations in aircrafts driven by electric propulsion systems. Certain aspects of the present disclosure generally relate to systems and methods for flight control of aircrafts driven by electric propulsion systems and in other types of vehicles, as well as flight control of aircrafts in flight simulators and video games. Other aspects of the present disclosure generally relate to improvements in flight control systems and methods that provide particular advantages in aerial vehicles and may be used in other types of vehicles.

### BACKGROUND

The inventors here have recognized several problems that may be associated with flight control of aircraft, including a tilt-rotor aircraft that uses electrical or hybrid-electric propulsion systems (hereinafter referred to as electric propulsion units or “EPUs”). Conventional aircraft typically have a one-to-one relationship between actuators and aircraft authority limits that may allow pilots to make sense of how close they are to the aircraft's authority limits. For example, in a conventional airplane, the airplane may be configured such that the elevator controls pitch, engines control thrust, ailerons control roll, and the engines are used purely to generate thrust. With such one-to-one configuration, pilots can easily look at, for example, a controlling lever and/or a display of a control surface position (e.g., elevator position) to determine a proximity to an authority limit (e.g., proximity of the thrust lever to the limit, proximity of engine torque to a limit, etc.).

While a one-to-one configuration is feasible for most conventional airplanes, it may be very difficult to apply the same configuration to over-actuated airplanes that have actuators controlling multiple axes. Such may be the case for the over-actuated aircraft of the present disclosure wherein one or more actuators of the aircraft may be configured to control multiple axes in certain phases of flight. For example, in hover and/or transition modes, engines of the disclosed aircraft may be configured to control roll, pitch, yaw, and thrust, meaning there may be a more complicated relationship between actuators and aircraft authority limits. Over the course of a flight, the pilot will need information on how much authority they have remaining in each control axes to safely fly the aircraft no matter the phase of flight. However, because the relationship between actuators and aircraft authority limits in an over-actuated aircraft is not a simple one-to-one relationship during certain phases of flight, and may change as the aircraft state changes, the pilot may have difficulty making sense of how close they are to the aircraft authority limits. Thus, there is a need for improved systems and methods for dynamically determining and outputting leveraged actuation authority on an intuitive reference display.

### SUMMARY

The present disclosure relates generally to flight control of electric aircraft and other powered aerial vehicles. More particularly, and without limitation, the present disclosure relates to innovations in tilt-rotor aircraft that use electrical propulsion systems. For example, certain aspects of the present disclosure relate to providing a control margin display for an aircraft. Further, certain embodiments may adjust the control margin display according to control signals, environmental variables, or other factors relating to the aircraft state.

Disclosed embodiments may include a control margin function configured to dynamically determine a relationship between pilot input commands and aircraft authority limits and present the determined relationship on a pilot display. For example, the control margin function may be configured to determine how much authority is remaining in each control axis (e.g., longitudinal speed, lateral speed, vertical speed, turn-rate), and may generate a control margin display comprising a spatial relation of one or more points representing the received one or more input commands in relation to one or more reference objects representing aircraft authority limits. This may occur in response to the flight control system (FCS) receiving one or more input commands via one or more pilot inceptors. The control margin function may provide effective command correction measures in situations where the aircraft may deviate from intended commands (e.g., when the aircraft does not move as commanded by the pilot due to a lack of remaining aircraft authority), which may help to prevent pilot-induced oscillations (PIOs). It may also provide regularly updated control authority information to a pilot, which is otherwise unobservable. Further, it may also provide increased situational awareness of the pilot, such as possible detection of an unannunciated actuator failure by observing a shift in control authority.

One aspect of the present disclosure comprises a method for dynamically moving graphical elements of a user interface of a flight control system, comprising: determining aircraft authority limits based on at least one state signal indicating an aircraft state, wherein the aircraft authority limits indicate an extent to which a control signal can command the aircraft; determining one or more proximities between the aircraft state and the determined aircraft authority limits; and automatically moving the graphical elements of the user interface to one or more positions on the user interface based on the determined one or more proximities.

Another aspect of the present disclosure comprises a flight control system, including at least one processor configured to: determine aircraft authority limits based on at least one state signal indicating aircraft state, wherein the aircraft authority limits indicate an extent to which a control signal can command the aircraft; determine one or more proximities between the aircraft state and the determined aircraft authority limits; and automatically moving the graphical elements of the user interface to one or more positions on the user interface based on the determined one or more proximities.

### BRIEF DESCRIPTION OF FIGURES

FIG. 1 shows an exemplary vertical takeoff and landing (VTOL) aircraft, consistent with disclosed embodiments.

FIG. 2 shows an exemplary VTOL aircraft, consistent with disclosed embodiments.

FIG. 3 shows an exemplary top plan view of a VTOL aircraft, consistent with disclosed embodiments.

FIG. 4 illustrates exemplary propeller rotation of a VTOL aircraft, consistent with disclosed embodiments.

FIG. 5 shows exemplary power connections in a VTOL aircraft, consistent with disclosed embodiments.

FIG. 6 shows an exemplary architecture of an electric propulsion unit, consistent with disclosed embodiments.

FIG. 7 shows an exemplary top plan view of a VTOL aircraft, consistent with disclosed embodiments.

FIG. 8 shows an exemplary flight control signaling architecture, consistent with disclosed embodiments.

FIGS. 9A-9F illustrate exemplary top plan views of VTOL aircraft, consistent with disclosed embodiments.

FIG. 10 illustrates a functional block diagram of an exemplary control system of an electric VTOL aircraft, consistent with disclosed embodiments.

FIG. 11 illustrates a block diagram of an exemplary method of control margin display, consistent with disclosed embodiments.

FIGS. 12A-12D illustrate configurations for control margin display, consistent with disclosed embodiments.

### DETAILED DESCRIPTION

The present disclosure addresses systems, components, and techniques primarily for use in an aircraft. The aircraft may be an aircraft with a pilot, an aircraft without a pilot (e.g., a UAV), a drone, a helicopter, and/or an airplane. An aircraft includes a physical body and one or more components (e.g., a wing, a tail, a propeller) configured to allow the aircraft to fly. The aircraft may include any configuration that includes at least one propeller. In some embodiments, the aircraft is driven by one or more electric propulsion systems (hereinafter referred to as electric propulsion units or “EPUs”). The aircraft may be fully electric, hybrid, or gas powered. For example, in some embodiments, the aircraft is a tilt-rotor aircraft configured for frequent (e.g., over 50 flights per work day), short-duration flights (e.g., less than 100 miles per flight) over, into, and out of densely populated regions. The aircraft may be configured to carry 4-6 passengers or commuters who have an expectation of a comfortable experience with low noise and low vibration. Accordingly, it is desirable to provide a control margin display that informs a pilot how close they are to aircraft authority limits, information that may be otherwise unavailable or difficult to assess, particularly in over-actuated aircraft.

Disclosed embodiments provide new and improved configurations of aircraft components, some of which are not observed in conventional aircraft, and/or identified design criteria for components that differ from those of conventional aircraft. Such alternate configurations and design criteria, in combination addressing drawbacks and challenges with conventional components, yielded the embodiments disclosed herein for various configurations and designs of components for an aircraft (e.g., electric aircraft or hybrid-electric aircraft) driven by a propulsion system.

In some embodiments, the aircraft driven by a propulsion system of the present disclosure may be designed to be capable of both vertical and conventional takeoff and landing, with a distributed propulsion system enabling vertical flight, horizontal and lateral flight, and transition (e.g., transitioning between vertical flight and horizontal flight). The aircraft may generate thrust by supplying high voltage electrical power to a plurality of engines of the distributed propulsion system, which may include components to convert the high voltage electrical power into mechanical shaft power to rotate a propeller.

Embodiments may include an electric engine (e.g., motor) connected to an onboard electrical power source, which may include a device capable of storing energy such as a battery or capacitor, and may optionally include one or more systems for harnessing or generating electricity such as a fuel powered generator or solar panel array. In some embodiments, the aircraft may comprise a hybrid aircraft using at least one of an electric-based energy source or a fuel-based energy source to power the distributed propulsion system. In some embodiments, the aircraft may be powered by one or more batteries, internal combustion engines (ICE), generators, turbine engines, or ducted fans.

The engines may be mounted directly to the wing, or mounted to one or more booms attached to the wing. The amount of thrust each engine generates may be governed by a torque command from a Flight Control System (FCS) over a digital communication interface to each engine. Embodiments may include forward engines (and associated propellers) that are capable of altering their orientation, or tilt.

The engines may rotate the propellers in a clockwise or counterclockwise direction. In some embodiments, the difference in propeller rotation direction may be achieved using the direction of engine rotation. In other embodiments, the engines may all rotate in the same direction, and gearing may be used to achieve different propeller rotation directions.

In some embodiments, an aircraft may possess quantities of engines in various combinations of forward and aft engine configurations. A forward engine may be considered an engine that is positioned predominantly towards the leading edge of a wing. An aft engine may be considered an engine that is positioned predominantly towards the trailing edge of a wing. For example, an aircraft may possess six forward and six aft engines, five forward and five aft engines, four forward and four aft engines, three forward and three aft engines, two forward and two aft engines, or any other combination of forward and aft engines, including embodiments where the number of forward engines and aft engines are not equivalent.

In some embodiments, for a vertical takeoff and landing (VTOL) mission, the forward and aft engines may provide vertical thrust during takeoff and landing. During flight phases where the aircraft is moving forward, the forward engines may provide horizontal thrust, while the propellers of the aft engines may be stowed at a fixed position in order to minimize drag. The aft engines may be actively stowed with position monitoring.

Transition from vertical flight to horizontal flight and vice-versa may be accomplished via the tilt propeller subsystem. The tilt propeller subsystem may redirect thrust between a primarily vertical direction during vertical flight phase (e.g., hover-phase) to a horizontal or near-horizontal direction during a forward-flight cruising phase, based on a tilt of one or more propellers (e.g., determining directionality of one or more propellers). A variable pitch mechanism may change the forward engine's propeller-hub assembly blade collective angles for operation during phases of flight, such as a hover-phase, transition phase, and cruise-phase. Vertical lift may be thrust in a primarily vertical direction (e.g., during a hover-phase). Horizontal thrust may be thrust in a primarily horizontal direction (e.g., during a cruise-phase).

In some embodiments, a “phase of flight,” or “flight mode,” (e.g., hover, cruise, forward flight, takeoff, landing, transition) may be defined by a combination of flight conditions. The combination of flight conditions may be defined by one or more flight parameters, such as airspeed, altitude, pitch angle (e.g., of the aircraft), tilt angle (e.g., of one or more propellers), roll angle, rotation speed (e.g., of a propeller), torque value, pilot command, or any other value indicating a current or requested (e.g., commanded) state of at least part of the aircraft.

In some embodiments, in a conventional takeoff and landing (CTOL) mission, the forward engines may provide horizontal thrust for wing-borne take-off, cruise, and landing, and the wings may provide vertical lift. In some embodiments, the aft engines may not be used for generating thrust during a CTOL mission and the aft propellers may be stowed in place. In other embodiments, the aft engines may be used at reduced power to shorten the length of the CTOL takeoff or landing.

As detailed above, embodiments of the aircraft may include many movable structural flight elements that allow pilots to safely control the aircraft. In over-actuated aircrafts, one or more of the movable structural flight elements (e.g., actuators) may be configured to control multiple axes in certain phases of flight. Therefore, there may not exist a one-to-one correspondence between a position of a controller (e.g., inceptor) and a position of a control surface or actuator.

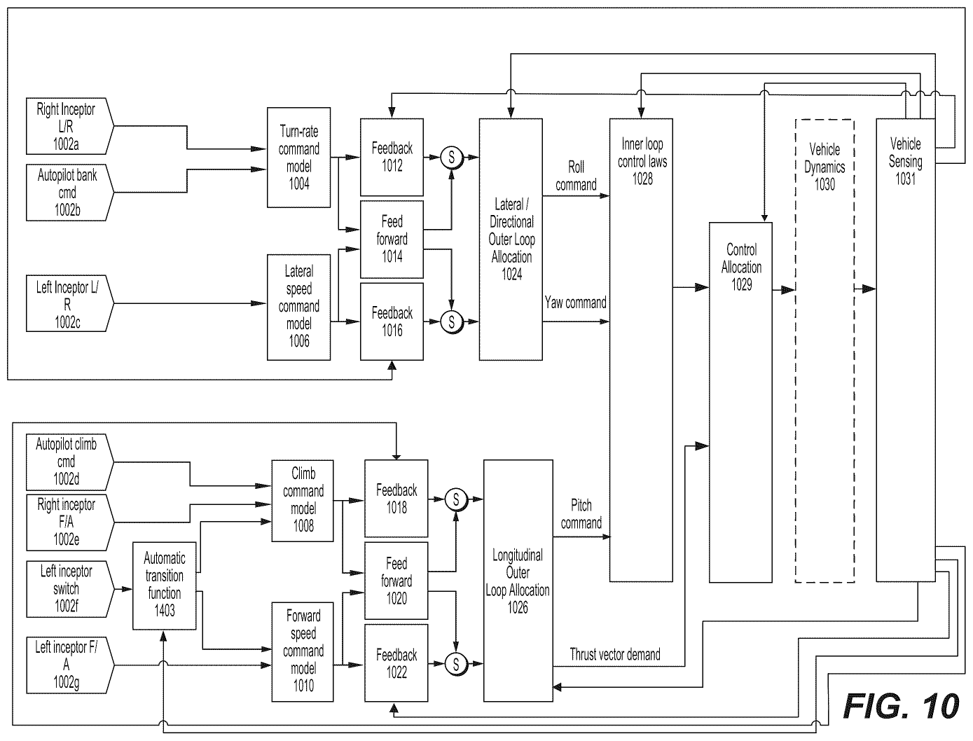

In some embodiments, an aircraft of any of the disclosed embodiments may be simulated. For example, the aircraft may be in a simulated environment in a simulator (e.g., a simulator for flight training) or a virtual environment in a video game. Additionally or alternatively, in some embodiments, a display of an aircraft may be simulated. For example, the display (e.g., control margin display) may be in a simulated environment in a simulator (e.g., a simulator for flight training) or a virtual environment in a video game. A representation of the simulated display may be displayed on a display device (e.g., monitor, tablet, smartphone, computer screen, or any other display device) operatively connected to a processor configured to execute software code stored in a storage medium for performing flight controls operations, such as those further detailed below with reference to FIG. 10.

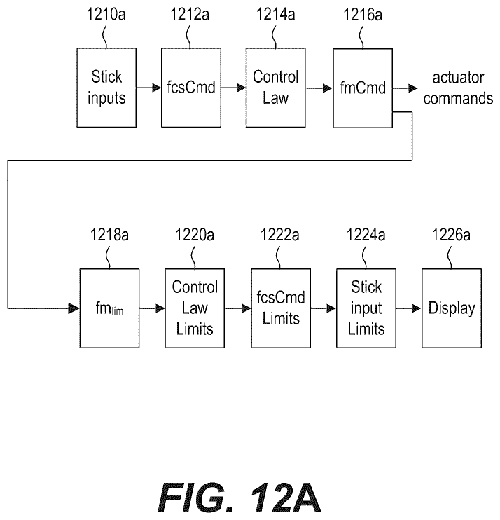

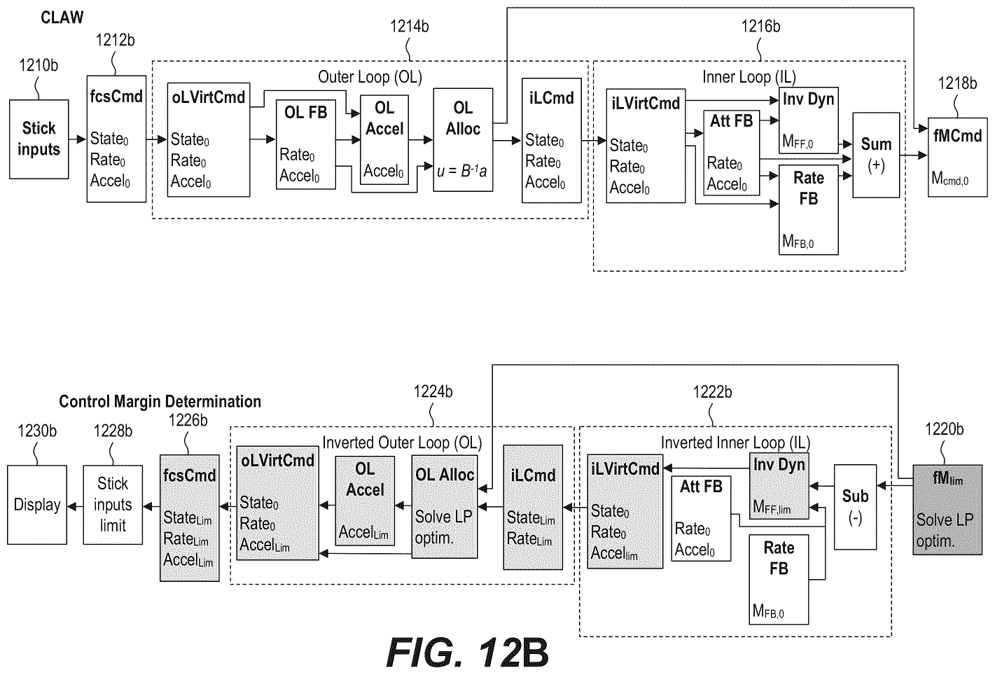

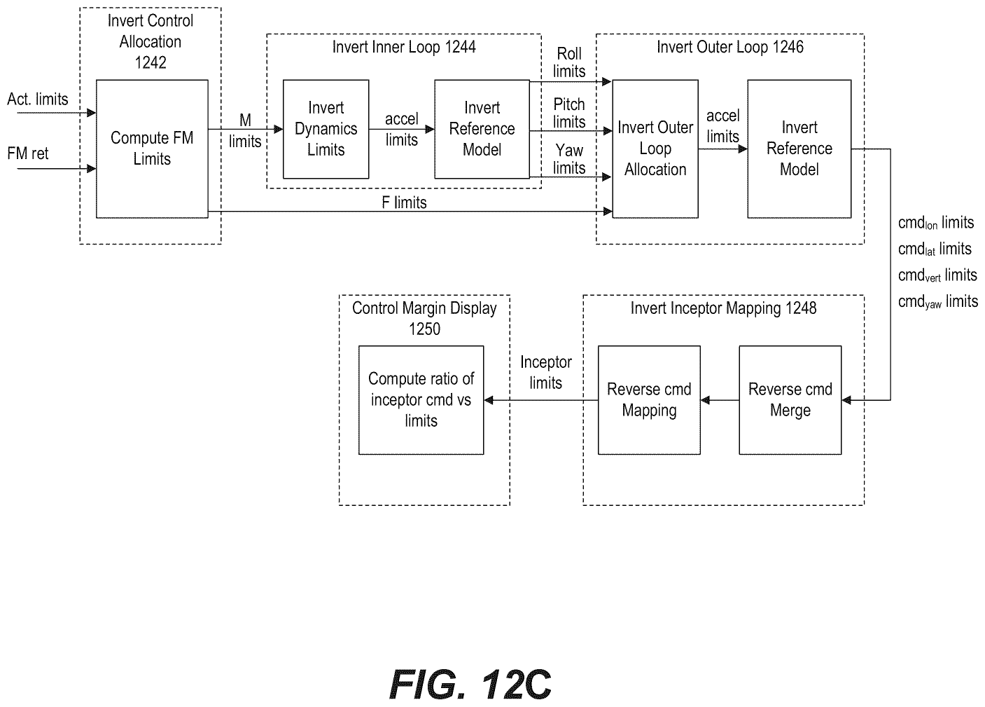

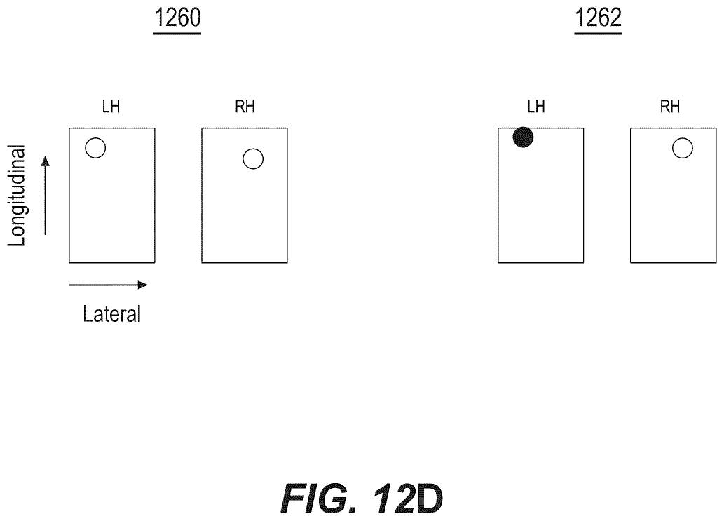

As further detailed below and with reference to FIGS. 12A-12D, the disclosed embodiments provide a control margin display that accurately inform a pilot of an aircraft state relative to determined aircraft authority limits.

Reference will now be made in detail to exemplary embodiments, examples of which are illustrated in the accompanying drawings. The following description refers to the accompanying drawings in which the same or similar numbers (e.g., 302 and 702, 410 and 1010) in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the subject matter recited in the appended claims.

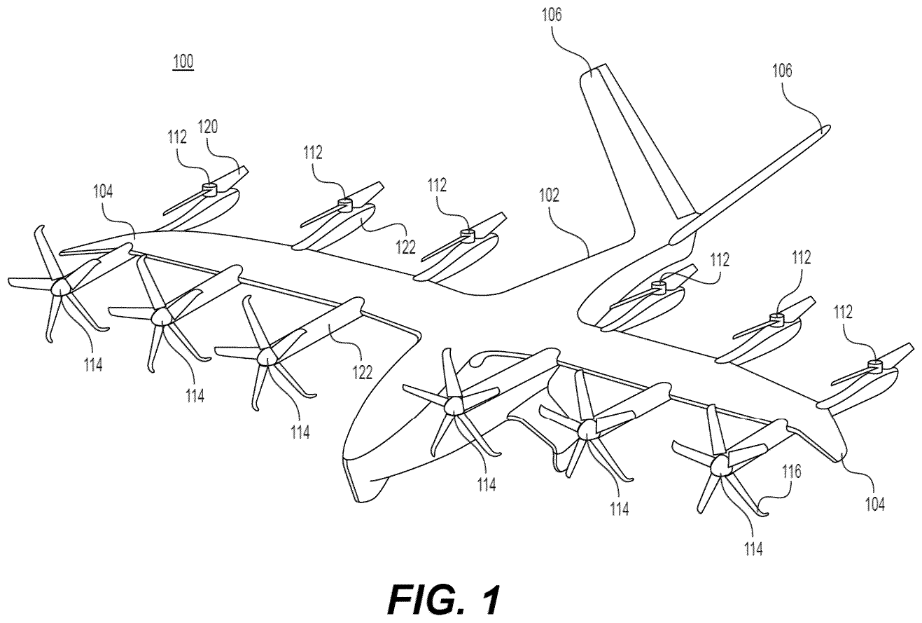

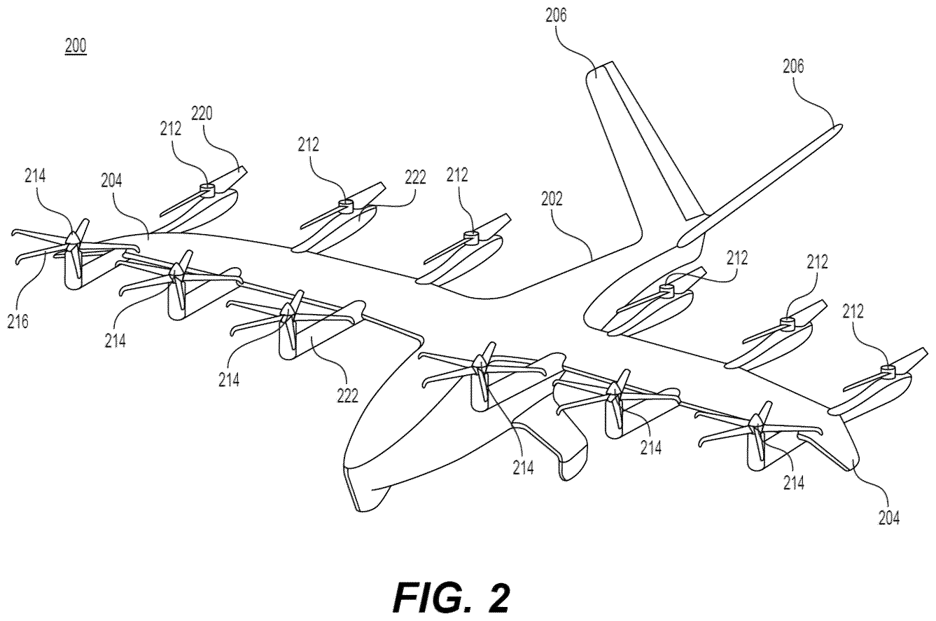

FIG. 1 is an illustration of a perspective view of an exemplary VTOL aircraft, consistent with disclosed embodiments. FIG. 2 is another illustration of a perspective view of an exemplary VTOL aircraft in an alternative configuration, consistent with embodiments of the present disclosure. FIGS. 1 and 2 illustrate a VTOL aircraft 100, 200 in a cruise configuration and a vertical take-off, landing and hover configuration (also referred to herein as a “lift” configuration), respectively, consistent with embodiments of the present disclosure. Elements corresponding to FIGS. 1 and 2 may possess like numerals and refer to similar elements of the aircrafts 100, 200. The aircraft 100, 200 may include a fuselage 102, 202, wings 104, 204 mounted to the fuselage 102, 202 and one or more rear stabilizers 106, 206 mounted to the rear of the fuselage 102, 202. A plurality of lift propellers 112, 212 may be mounted to wings 104, 204, and may be configured to provide lift for vertical take-off, landing and hover. A plurality of tilt propellers 114, 214 may be mounted to wings 104, 204 and may be tiltable (e.g., configured to tilt or alter orientation) between the lift configuration in which they provide a portion of the lift required for vertical take-off, landing and hovering, as shown in FIG. 2, and the cruise configuration in which they provide forward thrust to aircraft 100 for horizontal flight, as shown in FIG. 1. As used herein, a tilt propeller lift configuration refers to any tilt propeller orientation in which the tilt propeller thrust is providing primarily lift to the aircraft and tilt propeller cruise configuration refers to any tilt propeller orientation in which the tilt propeller thrust is providing primarily forward thrust to the aircraft.

In some embodiments, lift propellers 112, 212 may be configured for providing lift only, with all horizontal propulsion being provided by the tilt propellers. For example, lift propellers 112, 212 may be configured with fixed positions and may only generate thrust during take-off, landing and hover phases of flight. Meanwhile, tilt propellers 114, 214 may be tilted upward into a lift configuration in which thrust from propellers 114, 214 is directed downward to provide additional lift.

For forward flight, tilt propellers 114, 214 may tilt from their lift configurations to their cruise configurations. In other words, the orientation of tilt propellers 114, 214 may be varied from an orientation in which the tilt propeller thrust is directed downward (to provide lift during vertical take-off, landing and hover) to an orientation in which the tilt propeller thrust is directed rearward (to provide forward thrust to aircraft 100, 200). The tilt propellers assembly for a particular electric engine may tilt about an axis of rotation defined by a mounting point connecting the boom and the electric engine. When the aircraft 100, 200 is in full forward flight, lift may be provided entirely by wings 104, 204. Meanwhile, in the cruise configuration, lift propellers 112, 212 may be shut off. The blades 120, 220 of lift propellers 112, 212 may be held in low-drag positions for aircraft cruising. In some embodiments, lift propellers 112, 212 may each have two blades 120, 220 that may be locked, for example while the aircraft is cruising, in minimum drag positions in which one blade is directly in front of the other blade as illustrated in FIG. 1. In some embodiments, lift propellers 112, 212 have more than two blades. In some embodiments, tilt propellers 114, 214 may include more blades 116, 216 than lift propellers 112, 212. For example, as illustrated in FIGS. 1 and 2, lift propellers 112, 212 may each include, e.g., two blades, whereas and tilt propellers 114, 214 may each include more blades, such as the five blades shown. In some embodiments, each of the tilt propellers 114, 214 may have 2 to 5 blades, and possibly more depending on the design considerations and requirements of the aircraft.

In some embodiments, the aircraft may include a single wing 104, 204 on each side of fuselage 102, 202 (or a single wing that extends across the entire aircraft). At least a portion of lift propellers 112, 212 may be located rearward of wings 104, 204 (e.g., rotation point of propeller is behind a wing from a bird's eye view) and at least a portion of tilt propellers 114, 214 may be located forward of wings 104, 204 (e.g., rotation point of propeller is in front of a wing from a bird's eye view). In some embodiments, all of lift propellers 112, 212 may be located rearward of wings 104, 204 and all of tilt propellers 114, 214 may be located forward of wings 104, 204. According to some embodiments, all lift propellers 112, 212 and tilt propellers 114, 214 may be mounted to the wings—e.g., no lift propellers or tilt propellers may be mounted to the fuselage. In some embodiments, lift propellers 112, 212 may be all located rearwardly of wings 104, 204 and tilt propellers 114, 214 may be all located forward of wings 104, 204. According to some embodiments, all lift propellers 112, 212 and tilt propellers 114, 214 may be positioned inwardly of the ends of the wing 104, 204.

In some embodiments, lift propellers 112, 212 and tilt propellers 114, 214 may be mounted to wings 104, 204 by booms 122, 222. Booms 122, 222 may be mounted beneath wings 104, 204, on top of the wings, and/or may be integrated into the wing profile. In some embodiments, lift propellers 112, 212 and tilt propellers 114, 214 may be mounted directly to wings 104, 204. In some embodiments, one lift propeller 112, 212 and one tilt propeller 114, 214 may be mounted to each boom 122, 222. Lift propeller 112, 212 may be mounted at a rear end of boom 122, 222 and tilt propeller 114, 214 may be mounted at a front end of boom 122, 222. In some embodiments, lift propeller 112, 212 may be mounted in a fixed position on boom 122, 222. In some embodiments, tilt propeller 114, 214 may mounted to a front end of boom 122, 222 via a hinge. Tilt propeller 114, 214 may be mounted to boom 122, 222 such that tilt propeller 114, 214 is aligned with the body of boom 122, 222 when in its cruise configuration, forming a continuous extension of the front end of boom 122, 222 that minimizes drag for forward flight.

In some embodiments, aircraft 100, 200 may include, e.g., one wing on each side of fuselage 102, 202 or a single wing that extends across the aircraft. According to some embodiments, the at least one wing 104, 204 is a high wing mounted to an upper side of fuselage 102, 202. According to some embodiments, the wings include control surfaces, such as flaps, ailerons, and/or flaperons (e.g., configured to perform functions of both flaps and ailerons). According to some embodiments, wings 104, 204 may have a profile that reduces drag during forward flight. In some embodiments, the wing tip profile may be curved and/or tapered to minimize drag.

In some embodiments, rear stabilizers 106, 206 include control surfaces, such as one or more rudders, one or more elevators, and/or one or more combined rudder-elevators. The wing(s) may have any suitable design for providing lift, directionality, stability, and/or any other characteristic beneficial for aircraft. In some embodiments, the wings have a tapering leading edge.

In some embodiments, lift propellers 112, 212 or tilt propellers 114, 214 may be canted relative to at least one other lift propeller 112, 212 or tilt propeller 114, 214, where canting refers to a relative orientation of the rotational axis of the lift propeller/tilt propeller about a line that is parallel to the forward-rearward direction, analogous to the roll degree of freedom of the aircraft.

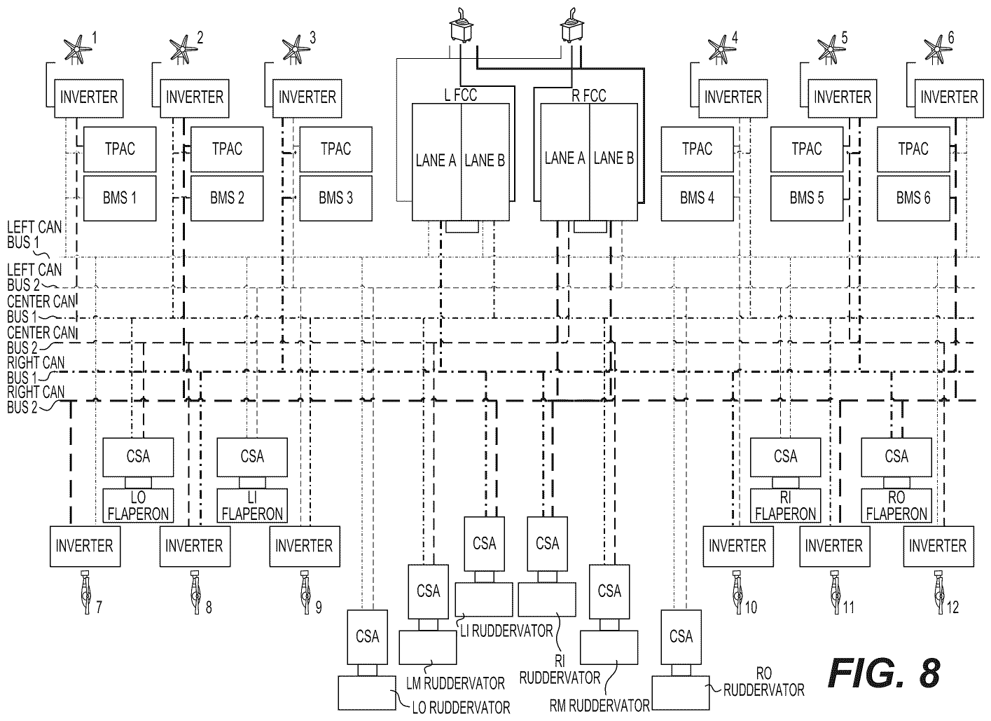

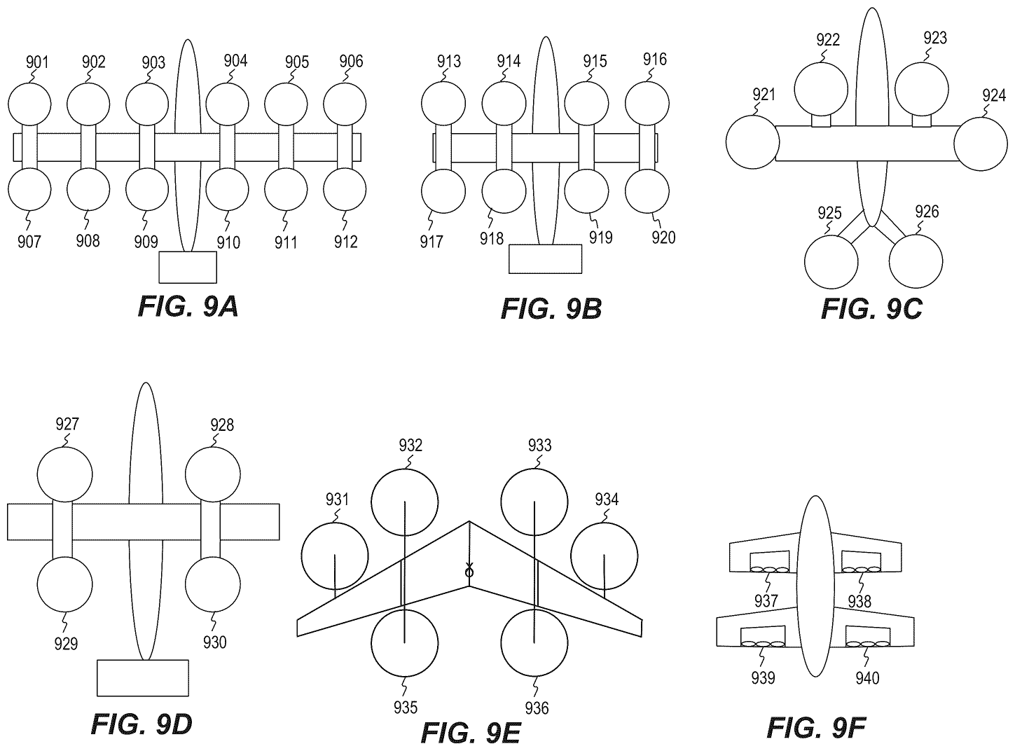

In some embodiments, one or more lift propellers 112, 212 and/or tilt propellers 114, 214 may canted relative to a cabin of the aircraft, such that the rotational axis of the propeller in a lift configuration is angled away from an axis perpendicular to the top surface of the aircraft. For example, in some embodiments, the aircraft is a flying wing aircraft as shown in FIG. 9E below, and some or all of the propellers are canted away from the cabin.

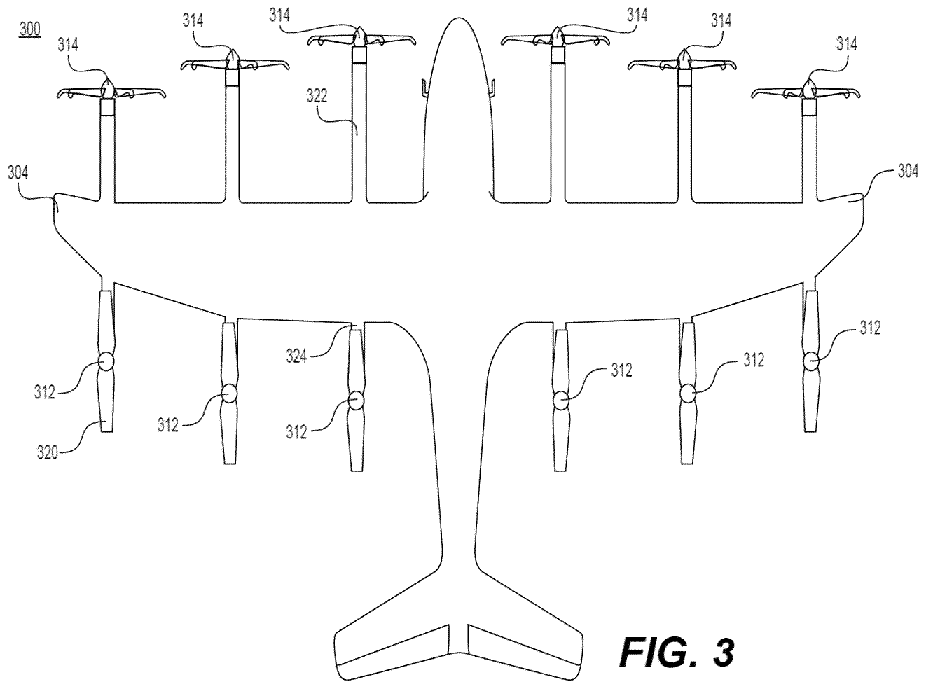

FIG. 3 is an illustration of a top plan view of an exemplary VTOL aircraft, consistent with embodiments of the present disclosure. Aircraft 300 shown in the figure may be a top plan view of the aircraft 100, 200 shown in FIGS. 1 and 2, respectively. As discussed herein, an aircraft 300 may include twelve electric propulsion systems distributed across the aircraft 300. In some embodiments, a distribution of electric propulsion systems may include six forward electric propulsion systems 314 and six aft electric propulsion systems 312 mounted on booms forward and aft of the main wings 304 of the aircraft 300. In some embodiments, a length of the rear end of the boom 324 from the wing 304 to a lift propeller (part of electric propulsion system 312) may comprise a similar rear end of the boom 324 length across the numerous rear ends of the booms. In some embodiments, the length of the rear ends of the booms may vary, for example, across the six rear ends of the booms. Further, FIG. 3 depicts an exemplary embodiment of a VTOL aircraft 300 with forward propellers (part of electric propulsion system 314) in a horizontal orientation for horizontal flight and aft propeller blades 320 in a stowed position for a forward phase of flight.

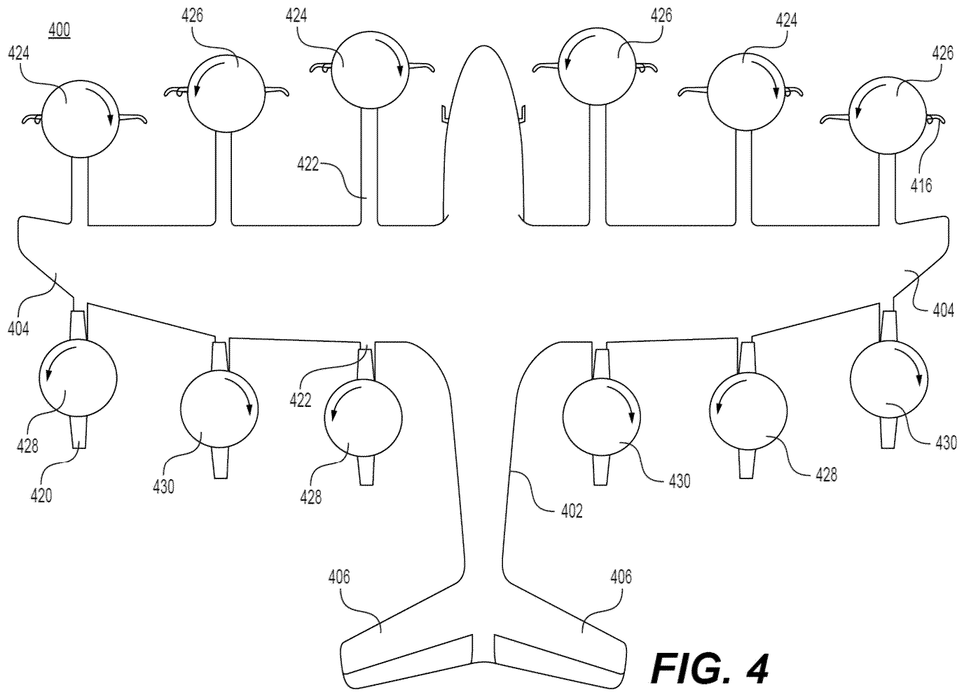

FIG. 4 is a schematic diagram illustrating exemplary propeller rotation of a VTOL aircraft, consistent with disclosed embodiments. Aircraft 400 shown in the figure may be a top plan view of the aircraft 100, 200, and 300 shown in FIGS. 1, 2, and 3, respectively. An aircraft 400 may include six forward electric propulsion systems with three of the forward electric propulsion systems being of CW type 424 and the remaining three forward electric propulsion systems being of CCW type. In some embodiments, three aft electric propulsion systems may be of CCW type 428 with the remaining three aft electric propulsion systems being of CW type 430. Some embodiments may include an aircraft 400 possessing four forward electric propulsion systems and four aft electric propulsion systems, each with two CW types and two CCW types. In some embodiments, propellers may counter-rotate with respect to adjacent propellers to cancel torque steer, generated by the rotation of the propellers, experienced by the fuselage or wings of the aircraft. In some embodiments, the difference in rotation direction may be achieved using the direction of engine rotation. In other embodiments, the engines may all rotate in the same direction, and gearing may be used to achieve different propeller rotation directions.

Some embodiments may include an aircraft 400 possessing forward and aft electric propulsion systems where the amount of CW types 424 and CCW types 426 is not equal among the forward electric propulsion systems, among the aft electric propulsion systems, or among the forward and aft electric propulsion systems.

FIG. 5 is a schematic diagram illustrating exemplary power connections in a VTOL aircraft, consistent with disclosed embodiments. A VTOL aircraft may have multiple power systems connected to diagonally opposing electric propulsion systems. In some embodiments, the power systems may include high voltage power systems. Some embodiments may include high voltage power systems connected to electric engines via high voltage channels. In some embodiments, an aircraft 500 may include six power systems (e.g., battery packs), including power systems 526, 528, 530, 532, 534, and 536 stored within the wing 570 of the aircraft 500. The power systems may power electric propulsion systems and/or other electric components of the aircraft 500. In some embodiments, the aircraft 500 may include six forward electric propulsion systems having six electric engines 502, 504, 506, 508, 510, and 512 and six aft electric propulsion systems having six electric engines 514, 516, 518, 520, 522, and 524. In some embodiments, one or more power systems (e.g., battery packs) may include a battery management system (“BMS”) (e.g., one BMS for each battery pack). While six power systems are shown in FIG. 5, the aircraft 500 may include any number and/or configuration of power systems.

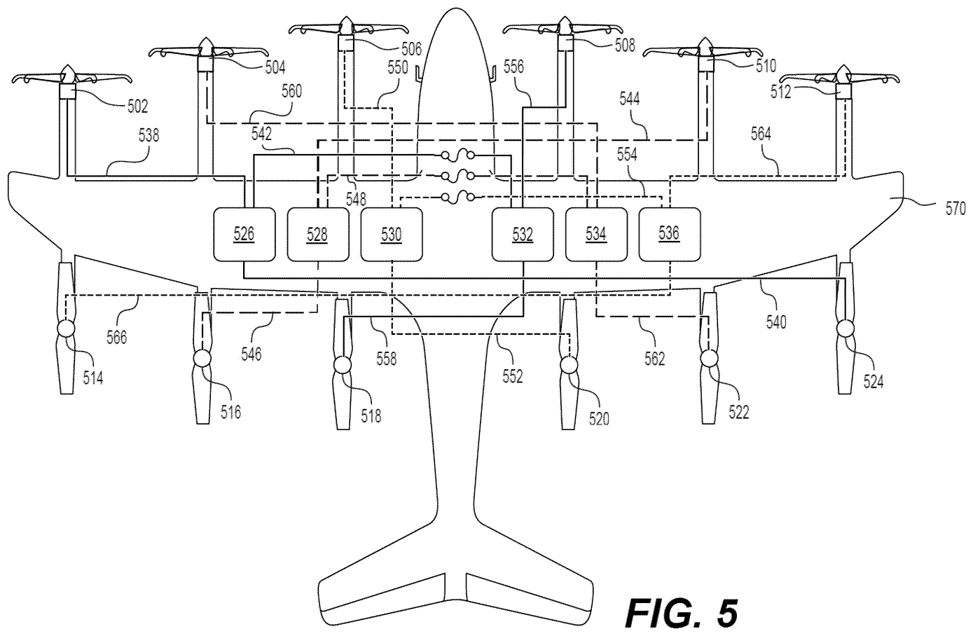

In some embodiments, the one or more battery management systems may communicate with a Flight Control System (“FCS”) of the aircraft (e.g., FCS 612 shown in FIG. 6). For example, the FCS may monitor the status of one or more battery packs and/or provide commands to the one or more battery management systems which make corresponding adjustments to the high voltage power supply. As described above, high frequency commands may increase power consumption. In some embodiments, as shown in FIG. 5, this power consumption may drain battery packs connected to multiple electric engines. Therefore, there is a need to control the aircraft in a manner that avoids high frequency commands.

FIG. 6 illustrates block diagram of an exemplary architecture and design of an electric propulsion unit 600 consistent with disclosed embodiments. Exemplary electric propulsion unit 600 includes an electric propulsion system 602, which may be configured to control aircraft propellers. Electric propulsion system 602 may include an electric engine subsystem 604 that may supply torque, via a shaft, to a propeller subsystem 606 to produce the thrust of the electric propulsion system 602. Some embodiments may include the electric engine subsystem 604 receiving low voltage direct current (LV DC) power from a Low Voltage System (LVS) 608. In some embodiments, the electric engine subsystem 604 may be configured to receive high voltage (HV) power from a High Voltage Power System (HVPS) 610 comprising at least one battery or other device capable of storing energy. HV power may refer to power that is lower in voltage than voltage provided by Low Voltage System (LVS) 608.

Some embodiments may include an electric propulsion system 602 including an electric engine subsystem 604 receiving signals from and sending signals to a flight control system 612. In some embodiments, a flight control system (FCS) 612 may comprise a flight control computer capable of using Controller Area Network (“CAN”) data bus signals to send commands to the electric engine subsystem 604 and receive status and data from the electric engine subsystem 604. It should be understood that while CAN data bus signals are used between the flight control computer and the electric engine(s), some embodiments may include any form of communication with the ability to send and receive data from a flight control computer to an electric engine. Some embodiments may include electric engine subsystems 604 capable of receiving operating parameters from and communicating operating parameters to an FCC in FCS 612, including speed, voltage, current, torque, temperature, vibration, propeller position, and/or any other value of operating parameters.

In some embodiments, a flight control system 612 may also include a Tilt Propeller System (“TPS”) 614 capable of sending and receiving analog, discrete data to and from the electric engine subsystem 604 of the tilt propellers. A tilt propeller system 614 may include an apparatus capable of communicating operating parameters to an electric engine subsystem 604 and articulating an orientation of the propeller subsystem 606 to redirect the thrust of the tilt propellers during various phases of flight using mechanical means such as a gearbox assembly, linear actuators, and any other configuration of components to alter an orientation of the propeller subsystem 606. In some embodiments, electric engine subsystem may communicate an orientation of the propeller system (e.g., an angle between lift and forward thrust) to TPS 614 and/or FCS 612 (e.g., during flight).

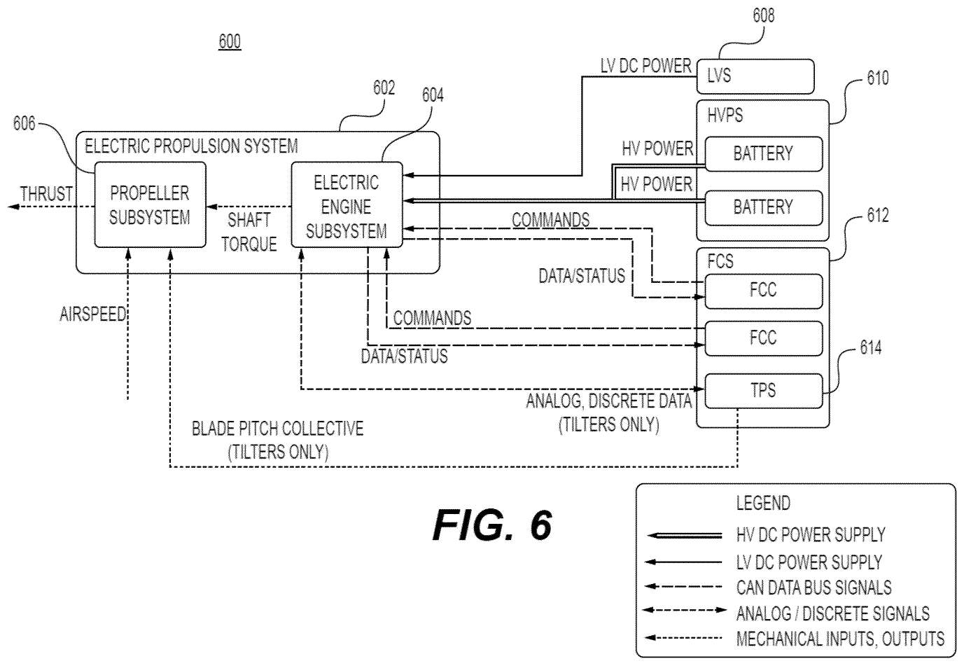

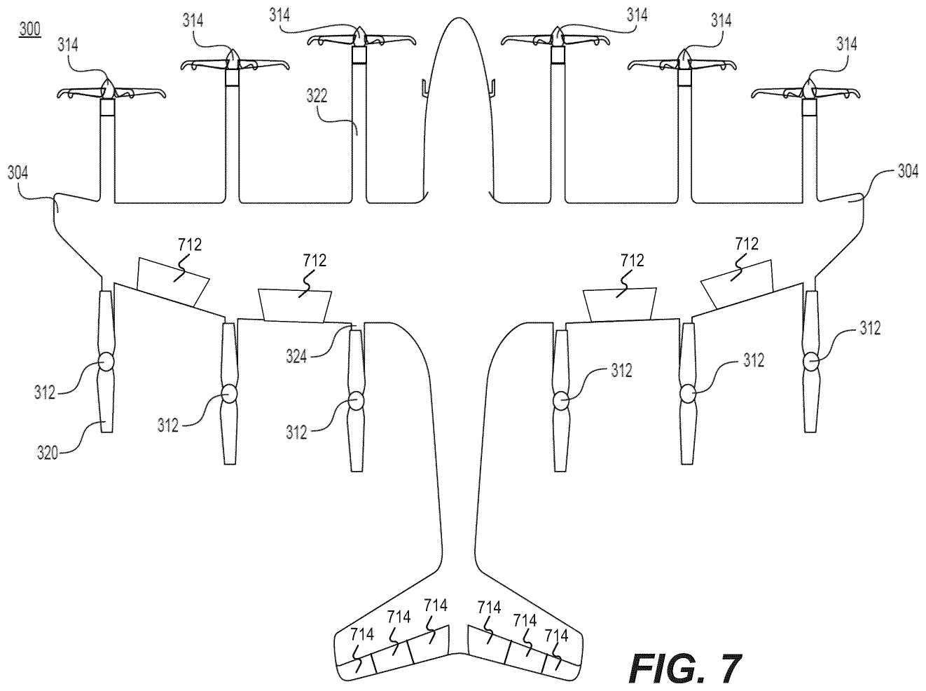

In some embodiments, a flight control system may include a system capable of controlling control surfaces and their associated actuators in an exemplary VTOL aircraft. FIG. 7 is an illustration of a top plan view of an exemplary VTOL aircraft, consistent with embodiments of the present disclosure. Aircraft 700 shown in the figure may be a top plan view of the aircraft 100, 200 shown in FIGS. 1 and 2, respectively. In aircraft 700, the control surfaces may include, in addition to the propeller blades discussed earlier, flaperons 712 and ruddervators 714. Flaperons 712 may combine functions of one or more flaps, one or more ailerons, and/or one or more spoilers. Ruddervators 714 may combine functions or one or more rudders and/or one or more elevators. Additionally or alternatively, control surfaces may include separate rudders and elevators. In aircraft 700, the actuators may include, in addition to the electric propulsion systems discussed earlier, control surface actuators (CSAs) associated with flaperons 712 and ruddervators 714, as discussed further below with reference to FIG. 8.

FIG. 8 illustrates a flight control signaling architecture for controlling the control surfaces and associated actuators, according to various embodiments. Although FIG. 7 illustrates twelve EPU inverters and associated propeller blades, six tilt propeller actuators (TPACs), six battery management systems (BMSs), four flaperons and associated control surface actuators (CSAs), and six ruddervators and associated CSAs, aircraft according to various embodiments can have any suitable number of these various elements. As shown in FIG. 8, control surfaces and actuators may be controlled by a combination of four flight control computers (FCCs)-Left FCC, Lane A (L FCC-A), Left FCC, Lane B (L FCC-B), Right FCC, Lane A (R FCC-A), and Right FCC, Lane A (R FCC-B), although any other suitable number of FCCs may be utilized. The FCCs may each individually control all control surfaces and actuators or may do so in any combination with each other. In some embodiments, each FCC may include one or more hardware computing processors. In some embodiments, each FCC may utilize a single-threaded computing process or a multi-threaded computing process to perform the computations required to control the control surfaces and actuators. In some embodiments, all computing process required to control the control surfaces and actuators may be performed on a single computing thread by a single flight control computer.

The FCCs may provide control signals to the control surface actuators, including the EPU inverters, TPACs, BMSs, flaperon CSAs, and ruddervator CSAs, via one or more bus systems. For different control surface actuators, the FCC may provide control signals, such as voltage or current control signals, and control information may be encoded in the control signals in binary, digital, or analog form. In some embodiments, the bus systems may each be a CAN bus system, e.g., Left CAN bus 1, Left CAN bus 2, Right CAN bus 1, Right CAN bus 2, Center CAN bus 1, Center CAN bus 2 (see FIG. 8). In some embodiments, multiple FCCs may be configured to provide control signals via each CAN bus system, and each FCC may be configured to provide control signals via multiple CAN bus systems. In the exemplary architecture illustrated in FIG. 8, for example, L FCC-A may provide control signals via Left CAN bus 1 and Right CAN bus 1, L FCC-B may provide control signals via Left CAN bus 1 and Center CAN bus 1, R FCC-A may provide control signals via Center CAN bus 2 and Right CAN bus 2, and R FCC-B may provide control signals via Left CAN bus 2 and Right CAN bus 2.

FIGS. 9A-9F are illustrations of a top plan view of exemplary VTOL aircrafts, consistent with embodiments of the present disclosure. There may be a number of design considerations (cost, weight, size, performance capability etc.) that may influence the number and/or combination of tilt and lift propellers in a VTOL aircraft. As further described below, the number and orientation of propellers may affect aircraft authority limits. Therefore, the flight control system may process control signals in different ways (e.g., those discussed in disclosed embodiments) to control the aircraft.

FIG. 9A illustrates an arrangement of electric propulsion units, consistent with embodiments of the present disclosure. Referring to FIG. 9A, the aircraft shown in the figure may be a top plan view of an exemplary aircraft (e.g., a VTOL aircraft). The aircraft may include twelve electric propulsion systems distributed across the aircraft. In some embodiments, a distribution of electric propulsion systems may include six forward electric propulsion systems (901, 902, 903, 904, 905, and 906) and six aft electric propulsion systems (907, 908, 909, 910, 911, and 912). In some embodiments, the six forward electric propulsion systems may be operatively connected to tilt propellers and the six aft electric propulsion systems may be operatively connected to lift propellers. In other embodiments, the six forward electric propulsion systems and a number of aft electric propulsion systems may be operatively connected to tilt propellers and the remaining aft electric propulsion systems may be operatively connected to lift propellers. In other embodiments, all forward and aft electric propulsion systems may be operatively coupled to tilt propellers.

FIG. 9B illustrates an alternate arrangement of electric propulsion units, consistent with embodiments of the present disclosure. Referring to FIG. 9B, the aircraft shown in the figure may be a top plan view of an exemplary aircraft (e.g., a VTOL aircraft). The aircraft may include eight electric propulsion systems distributed across the aircraft. In some embodiments, a distribution of electric propulsion systems may include four forward electric propulsion systems (913, 914, 915, and 916) and four aft electric propulsion systems (917, 918, 919, and 920). In some embodiments, the four forward electric propulsion systems may be operatively connected to tilt propellers and the four aft electric propulsion systems may be operatively connected to lift propellers. In other embodiments, the four forward electric propulsion systems and a number of aft electric propulsion systems may be operatively connected to tilt propellers and the remaining aft electric propulsion systems may be operatively connected to lift propellers. In other embodiments, all forward and aft electric propulsion systems may be operatively coupled to tilt propellers.

FIG. 9C illustrates an alternate arrangement of electric propulsion units, consistent with embodiments of the present disclosure. Referring to FIG. 9C, the aircraft shown in the figure may be a top plan view of an exemplary aircraft (e.g., a VTOL aircraft). The aircraft may include six electric propulsion systems distributed across the aircraft. In some embodiments, a distribution of electric propulsion systems may include a first set of four electric propulsion systems 921, 922, 923, and 924 coplanar in a first plane and a second set of two electric propulsion systems 925 and 926 coplanar in a second plane. In some embodiments, the first set of electric propulsion systems 921-924 may be operatively connected to tilt propellers and second set of electric propulsion systems 925 and 926 may be operatively connected to lift propellers. In other embodiments, the first set of electric propulsion systems 921-924 and the second set of aft electric propulsion systems 925 and 926 may all be operatively connected to tilt propellers.

FIG. 9D illustrates an alternate arrangement of electric propulsion units, consistent with embodiments of the present disclosure. Referring to FIG. 9D, the aircraft shown in the figure may be a top plan view of an exemplary aircraft (e.g., a VTOL aircraft). The aircraft may include four electric propulsion systems distributed across the aircraft. In some embodiments, a distribution of electric propulsion systems may include four coplanar electric propulsion systems 927, 928, 929, and 930. In some embodiments, all of the electric propulsion systems may be operatively connected to tilt propellers.

FIG. 9E illustrates an alternate arrangement of electric propulsion units, consistent with embodiments of the present disclosure. Referring to FIG. 9E, the aircraft shown in the figure may be a top plan view of an exemplary aircraft (e.g., a VTOL aircraft). The aircraft may include six electric propulsion systems distributed across the aircraft. For example, in some embodiments, the aircraft may include four forward electric propulsion systems 931, 932, 933, and 934 operatively connected to tilt propellers and the two aft electric propulsion systems 935 and 936 operatively connected to lift propellers. In some embodiments, the aircraft may include ten electric propulsion systems distributed across the aircraft. For example, in some embodiments, the aircraft may include six forward electric propulsion systems operatively connected to tilt propellers and the four aft electric propulsion systems operatively connected to lift propellers. In some embodiments, some or all of the aft electric propulsion systems may operatively connected to tilt propellers.

As shown in FIG. 9E, in some embodiments, the aircraft may have a flying wing configuration, such as a tailless fixed-wing aircraft with no definite fuselage. In some embodiments, the aircraft may have a flying wing configuration with the fuselage integrated into the wing. In some embodiments, the tilt propellers may rotate in a plane above the body of the aircraft when the tilt propellers operate in a lift configuration.

FIG. 9F illustrates an alternate arrangement of electric propulsion units, consistent with the embodiments of the present disclosure. Referring to FIG. 9F, the aircraft may be a top plan view of an exemplary aircraft. In some embodiments, the aircraft may include ducted fans 937, 938, 939, and 940 operably connected to the electric propulsion systems. In some embodiments the aircraft may include a bank of ducted fans on each wing of the aircraft and the bank of ducted fans may be connected to tilt together (e.g., between lift and forward thrust configuration). In some embodiments the aircraft includes a left and right front wing and a left and right rear wing. In some embodiments, each wing of the aircraft includes a bank of connected ducted fans. In some embodiments, each bank of connected ducted fans are tiltable (e.g., between lift and forward thrust), while in other embodiments only the bank of fans on the front wing(s) are tiltable.

As disclosed herein, the forward electric propulsion systems and aft electric propulsion systems may be of a clockwise (CW) type or counterclockwise (CCW) type. Some embodiments may include various forward electric propulsion systems possessing a mixture of both CW and CCW types. In some embodiments, the aft electric propulsion systems may possess a mixture of CW and CCW type systems among the aft electric propulsion systems. In some embodiments, each electric propulsion systems may be fixed as clockwise (CW) type or counterclockwise (CCW) type, while in other embodiments, one or more electric propulsion systems may vary between clockwise (CW) and counterclockwise (CCW) rotation.

FIG. 10 illustrates a functional block diagram of an exemplary control system 1000 of an aircraft, consistent with disclosed embodiments. System 1000 may be implemented by at least one processor (e.g., at least one microprocessor-based controller) configured to execute software code stored in a storage medium (e.g., a computer-readable medium, a non-transitory computer-readable medium) to implement the functions described herein. System 1000 may also be implemented in hardware, or a combination of hardware and software. System 1000 may be implemented as part of a flight control system of the aircraft (e.g., part of FCS 612 in FIG. 6) and may be configured to perform a single step or sequence repeatedly until a desired or commanded outcome is achieved. It is to be understood that many conventional functions of the control system are not shown in FIG. 10 for ease of description. System 1000 further includes one or more storage mediums storing model(s), function(s), table(s), and/or any information for executing the disclosed processes. As further described below, any or each box indicating a command model (e.g., 1004, 1006, 1008, and 1010), feedback (1012, 1016, 1018, and 1022), feed forward (1014, 1020), outer loop allocation (1024, 1026), inner loop control laws 1028, and control allocation 1029 may represent or include module(s), script(s), function(s), application(s), and/or program(s) that are executed by processor(s) and/or microprocessor(s) of the system 1000. It is appreciated that the complexity and interconnectedness of the functional block diagram of FIG. 10 would be impossible, or at least impractical, to effectively implement by a human user, especially when considering that these functionalities are implemented while the aircraft is flying (including taking off or landing).

In some embodiments, control system 1000 may be configured based on one or more flight control laws. Flight control law may comprise a set of algorithms, models, and/or rules configured to govern a behavior of an aircraft (e.g., control or influence one or more effectors of the aircraft) in response to one or more pilot inputs and external factors. In some embodiments, flight control laws may be configured to achieve at least one of desired flight characteristics, stability, or performance. For example, flight control laws may be configured to ensure stability and controllability of an aircraft by controlling how the aircraft responds to at least one of one or more pilot inputs, vehicle dynamics (e.g., disturbances, such as turbulence, gusts, etc.), or changes in flight conditions (e.g., altitude, airspeed, angle of attack).

System 1000 may detect one or more inputs, such as from a pilot input device configured to receive at least one pilot input and generate or influence a signal. A pilot input may be generated by and/or received from an input device or mechanism of the aircraft, such as a button, a switch, a stick, a slider, an inceptor, or any other device configured to generate or influence a signal based on a physical action from a pilot. For example, a pilot input device may include one or more of right inceptor(s) (e.g., moving left/right 1002a and/or forward/aft 1002e), left inceptor(s) (e.g., moving left/right 1002c and/or forward/aft 1002g), and/or left inceptor switch 1002f. In some embodiments, a pilot input device may include an interface with an autopilot system (e.g., display screen(s), switch(es), button(s), lever(s), and/or other interface(s)). Optionally, system 1000 may further detect inputs from an autopilot system, such as autopilot roll command 1002b, autopilot climb command 1002d, and/or other command(s) to control the aircraft.

In some embodiments, the one or more inputs may include at least one of a position and/or rate of a right inceptor and/or a left inceptor, signals received (e.g., response type change commands, trim inputs, backup control inputs, etc.) from switches on the inceptors, measurements of aircraft state and environmental conditions (e.g., measured load factor, airspeed, roll angle, pitch angle, actuator states, battery states, aerodynamic parameters, temperature, gusts, etc.) based on data received from one or more sensors of the aircraft, obstacles (e.g., presence or absence of other aircraft and/or debris), and an aircraft mode (e.g., taxiing on the ground, takeoff, in-air). For example, right inceptor L/R 1002a may comprise a lateral position and/or rate of a right inceptor (e.g., an inceptor positioned to the right of another inceptor and/or an inceptor positioned on the right side of a pilot area), autopilot roll command 1002b may comprise a roll signal received in autopilot mode, left inceptor L/R 1002c may comprise a lateral position and/or rate of a left inceptor (e.g., an inceptor positioned to the left of another inceptor and/or an inceptor positioned on the left side of a pilot area), autopilot climb command 1002d may comprise a climb signal received in autopilot mode, right inceptor F/A 1002e may comprise a longitudinal position and/or rate of the right inceptor, left inceptor switch 1002f may comprise a signal from a switch for enabling or disabling automatic transition function 1003, and left inceptor F/A 1002g may comprise a longitudinal position and/or rate of the left inceptor.

Each input may include additional data as listed above (e.g., signals from switches, measurements of aircraft state, aircraft mode, etc.). Actuator states may include actuator hardware limits, such as travel limits, speed limits, response time limits, etc., and can include actuator health indicators that may indicate deteriorations in actuator performance that may limit a given actuator's ability to satisfy actuator commands. Actuator states may be used to determine the bounds (e.g., minimum/maximum values) for individual actuator commands. Battery states may correspond to remaining energy of the battery packs of the aircraft, which may be monitored when control allocation 1029 considers balancing battery pack energy states. Aerodynamic parameters may be parameters derived from aerodynamic and acoustic modeling and can be based on the actuator Jacobian matrices and actuator states. Each input received from an inceptor may indicate a corresponding adjustment to an aircraft's heading or power output.

Command models 1004, 1006, 1008 and 1010 may be configured to determine a shape (e.g., aggressiveness, slew rate, damping, overshoot, etc.) of an ideal aircraft response. For example, each command model of command models 1004, 1006, 1008 and 1010 may be configured to receive and interpret at least one of inputs 1002a, 1002b, 1002c, 1002d, 1002e, 1002f and 1002g and, in response, compute a corresponding change to an aircraft's orientation, heading, and propulsion, or a combination thereof using an integrator (not pictured). In some embodiments, right inceptor L/R 1002a and autopilot roll command 1002b may be fed into turn-rate command model 1004, left inceptor L/R 1002c may be fed into lateral speed command model 1006, autopilot climb command 1002d and right inceptor F/A 1002e may be fed into climb command model 1008, and left inceptor F/A 1002g may be fed into forward speed command model 1010. In some embodiments, an output from automatic transition function 1003 may be fed into at least one of climb command model 1008 or forward speed command model 1010. For example, based on receiving an enable signal from left inceptor switch 1002f, automatic transition function 1003 may automatically determine at least one of a climb signal or a forward speed signal for transmission to at least one of climb command model 1008 or forward speed command model 1010.

Turn-rate command model 1004 may be configured to output a desired position and/or turn-rate command and may also be configured to compute a desired heading of the aircraft to be assumed when the inceptor is brought back to a centered position (e.g., in detent). Lateral speed command model 1006 may be configured to output a desired position and/or lateral speed command. Climb command model 1008 may be configured to output at least one of a desired altitude, vertical speed, or vertical acceleration command. Forward speed command model 1010 may be configured to output at least one of a desired position, longitudinal speed, or longitudinal acceleration command. In some embodiments, one or more of the command models may be configured to output an acceleration generated in response to changes in speed command. For example, climb command model 1008 may be configured to output a vertical acceleration generated in response to a change in vertical speed command.

Feed forward 1014 and 1020 may each receive as input one or more desired changes (e.g., desired position, speed and/or acceleration) from corresponding command models 1004, 1006, 1008 or 1010 as well as data received from the one or more aircraft sensors (e.g., airspeed, vehicle orientation, vehicle load factor, measured acceleration, vehicle mass and inertia, air density, altitude, aircraft mode, etc.) and may be configured to output, for each desired change, a corresponding force to accomplish the desired change. In some embodiments, feed forward 1014 and 1020 may be configured to determine the corresponding force using simplified models of aircraft dynamics. For example, based on a known (e.g., a stored value of) or determined mass of the aircraft, feed forward 1014 and 1020 may be configured to determine a force to cause the aircraft to follow a desired acceleration command. In some embodiments, feed forward 1014 and 1020 may be configured to use a model predicting an amount of drag on the vehicle produced as a function of speed in order to determine a force required to follow a desired speed command signal.

Feedback 1012, 1016, 1018, and 1022 may each receive as input the one or more desired changes (e.g., desired position, speed and/or acceleration) from command models 1004, 1006, 1008 and 1010 as well as data received from Vehicle Sensing 1031 indicative of Vehicle Dynamics 1030. For example, sensed Vehicle Dynamics 1030 may comprise a representation of the physics and/or natural dynamics of the aircraft, and Vehicle Dynamics Sensing 1031 sensor measurements may capture how the aircraft moves in response to pilot inputs, propulsion system outputs or ambient conditions. Additionally or alternatively, data received from Vehicle Sensing 1031 may include error signals generated, by one or more processors, based on exogenous disturbances (e.g., gust causing speed disturbance). In some embodiments, feedback 1012, 1016, 1018 and 1022 may be configured to generate feedback forces (e.g., at an actuator) based on the received error signals. For example, feedback 1012, 1016, 1018 and 1022 may generate feedback forces with the intent of counteracting the effect(s) of external disturbances. Additionally or alternatively, feedback 1012, 1016, 1018 and 1022 may be configured to generate feedback forces based on modeling errors. For example, if an incorrect aircraft mass is input into either feed forward 1014 or 1020, the aircraft may accelerate faster or slower than the desired change. Based on determining a difference between the desired acceleration and the measured acceleration, one or more processors may generate an error signal (e.g., included in Vehicle Sensing 1031) which may be looped into feedback 1012, 1016, 1018 or 1022 to determine an additional force needed to correct the error.

In some embodiments, feedback 1012, 1016, 1018 or 1022 may be disabled. For example, in response to losing position and/or ground speed feedback due to disruption of global position system (GPS) communication, system 1000 may be configured to operate without feedback 1012, 1016, 1018 or 1022 until GPS communication is reconnected.

In some embodiments, feedback 1012, 1016, 1018 or 1022 may receive as input a plurality of measurements as well as a trust value for each measurement indicating whether the measurement is valid. For example, one or more processors of system 1000 may assign a Boolean (true/false) value for each measurement used in system 1000 to indicate that the measurement is trustworthy (e.g., yes) or that the measurement may be invalid (e.g., no). Based on one or more processors identifying a measurement as invalid, feedback 1012, 1016, 1018 or 1022 may omit that measurement for further processing. For example, in response to one or more processors identifying a heading measurement as invalid, feedback 1012, 1016, 1018 or 1022 may omit subsequent heading measurements in determining feedback force(s).

In some embodiments, feedback 1012, 1016, 1018 or 1022 may determine one or more feedback forces based on actuator state information received from one or more sensors (e.g., included in vehicle sensing 1031). For example, in response to actuator state information indicating that there is a failure of an actuator, one or more processors of system 1000 may update one or more processes of System 1000 and determine an alternative command to achieve the desired change. For example, one or more processors of system 1000 may adjust one or more model(s), function(s), algorithm(s), table(s), input(s), parameter(s), threshold(s), and/or constraint(s) in response to the failure of an actuator. Alternative command(s) (e.g., yaw, pitch, roll, thrust, or torque) may be determined based on the adjustment(s). Additionally or alternatively, in response to actuator state information indicating that one or more actuators are at a maximum value, one or more processors of system 1000 may update one or more processes of system 1000 (e.g., as described above) and determine an alternative command to achieve the desired change.

Total desired forces may be calculated based on outputs of feedback 1012, 1016, 1018 and 1022 and feed forward 1014 and 1020. For example, one or more processors of system 1000 may calculate a desired turn-rate force by summing the outputs of feedback 1012 and feed forward 1014. Additionally or alternatively, one or more processors of system 1000 may calculate a desired lateral force by summing the outputs of feedback 1016 and feed forward 1014. Additionally or alternatively, one or more processors of system 1000 may calculate a desired vertical force by summing the outputs of feedback 1018 and feed forward 1020. Additionally or alternatively, one or more processors of system 1000 may calculate a desired longitudinal force by summing the outputs of feedback 1022 and feed forward 1020.

Lateral/Directional Outer Loop Allocation 1024 and Longitudinal Outer Loop Allocation 1026 may each be configured to receive as input one or more desired forces and data received from Vehicle Sensing 1031 (e.g., airspeed, vehicle orientation, vehicle load factor, measured acceleration, vehicle mass and inertia, indications of working/failed actuators, air density, altitude, aircraft mode, whether the aircraft is in the air or on the ground, weight on wheels, etc.). Based on the inputs, Outer Loop Allocation 1024 and 1026 may be configured to command roll, command yaw, command pitch, demand thrust, or output a combination of different commands/demands in order to achieve the one or more desired forces.

Lateral/Directional Outer Loop Allocation 1024 may receive as input a desired turn-rate force and/or a desired lateral force and may command roll or command yaw. In some embodiments, Lateral/Directional Outer Loop Allocation 1024 may determine output based on a determined flight mode. A flight mode may be determined using pilot inputs (e.g., a selected mode on an inceptor) and/or sensed aircraft information (e.g., an airspeed). For example, Lateral/Directional Outer Loop Allocation 1024 may determine a flight mode of the aircraft using at least one of a determined (e.g., sensed or measured) airspeed or an input received at a pilot inceptor button (e.g., an input instructing the aircraft to fly according to a particular flight mode). In some embodiments, Lateral/Directional Outer Loop Allocation 1024 may be configured to prioritize a pilot inceptor button input over measured airspeed in determining the flight mode (e.g., the pilot inceptor button is associated with a stronger weight or higher priority than a measured airspeed). In some embodiments, Lateral/Directional Outer Loop Allocation 1024 may be configured to blend (e.g., using weighted summation) the determined airspeed and pilot inceptor button input to determine the flight mode of the aircraft. In a hover flight mode, Lateral/Directional Outer Loop Allocation 1024 may achieve the desired lateral force with a roll command (e.g., roll angle, roll rate) and may achieve the desired turn-rate force with a yaw command. In some embodiments, such as in hover flight mode, the aircraft may be configured to not be able to accelerate outside a predetermined hover envelope (e.g., hover speed range). In a forward-flight mode (e.g., horizontal flight), Lateral/Directional Outer Loop Allocation 1024 may achieve the desired lateral force with a yaw command and may achieve the desired turn-rate force with a roll command. In forward flight mode, Lateral/Directional Outer Loop Allocation 1024 may be configured to determine output based on sensed airspeed. In a transition between hover flight mode and forward flight mode, Lateral/Directional Outer Loop Allocation 1024 may achieve desired forces using a combination of a roll command and a yaw command.

Longitudinal Outer Loop Allocation 1026 may receive as input a desired vertical force and/or a desired longitudinal force and may output at least one of a pitch command (e.g., pitch angle) or a thrust vector demand. A thrust vector demand may include longitudinal thrust (e.g., mix of nacelle tilt and front propeller thrust) and vertical thrust (e.g., combined front and rear thrust). In some embodiments, Longitudinal Outer Loop Allocation 1026 may determine output based on a determined flight mode. For example, in a hover flight mode, Longitudinal Outer Loop Allocation 1026 may achieve a desired longitudinal force by lowering a pitch attitude and by using longitudinal thrust, and may achieve a desired vertical force with vertical thrust. In a forward-flight mode, Longitudinal Outer Loop Allocation 1026 may achieve a desired longitudinal force with longitudinal thrust (e.g., front propeller thrust). In a cruise flight mode, Longitudinal Outer Loop Allocation 1026 may achieve a desired vertical force by commanding pitch (e.g., raising pitch attitude) and demanding thrust (e.g., increasing longitudinal thrust).

Inner loop control laws 1028 may be configured to determine moment commands based on at least one of a roll command, yaw command, or pitch command from Lateral/Directional Outer Loop Allocation 1024 or Longitudinal Outer Loop Allocation 1026. In some embodiments, Inner loop control laws 1028 may be dependent on sensed Vehicle Dynamics 1030 (e.g., from Vehicle Sensing 1031). For example, Inner loop control laws 1028 may be configured to compensate for disturbances at the attitude and rate level in order to stabilize the aircraft. Additionally or alternatively, Inner loop control laws 1028 may consider periods of natural modes (e.g., phugoid modes) that affect the pitch axis, and may control the aircraft appropriately to compensate for such natural modes of the vehicle. In some embodiments, inner loop control laws 1028 may be dependent on vehicle inertia.

Inner loop control laws 1028 may determine moment commands using one or more stored dynamics models that reflect the motion characteristics of the aircraft (e.g., the aerodynamic damping and/or inertia of the aircraft). In some embodiments, the inner loop control laws 1028 may use a dynamic model (e.g., a low order equivalent system model) to capture the motion characteristics of the aircraft and determine one or more moments that will cause the aircraft to achieve the commanded roll, yaw, and/or pitch. Some embodiments may include determining (e.g., by inner loop control laws 1028 or other component) a moment command based on at least one received command (e.g., a roll command, yaw command, and/or pitch command) and a determined (e.g., measured) aircraft state. For example, a moment command may be determined using a difference in the commanded aircraft state and the measured aircraft state. By way of further example, a moment command may be determined using the difference between a commanded roll angle and a measured roll angle. As described below, Control Allocation 1029 may control the aircraft (e.g., through flight elements) based on the determined moment command(s). For example, Control Allocation 1029 may control (e.g., transmit one or more commands to) one or more electric propulsion system(s) of the aircraft (e.g., electric propulsion system 602 shown in FIG. 6), including tilt actuator(s), electric engine(s), and/or propeller(s). Control Allocation 1029 may further control one or more control surface(s) of the aircraft (e.g., control surfaces, such as flaperons 712 and ruddervators 714 shown in FIG. 7), including flaperon(s), ruddervator(s), aileron(s), spoiler(s), rudder(s), and/or elevator(s). Vehicle Dynamics 1030 represents the control of different flight elements (e.g., electric propulsion system(s) and/or control surfaces) and the corresponding effect on the flight elements and aircraft dynamics.

While the embodiment shown in FIG. 10 includes both Inner loop control laws 1028 and Outer loop allocation 1024 and 1026, in some embodiments the flight control system may not include Outer loop allocation 1024 and 1026. Therefore, a pilot inceptor input may create roll, yaw, pitch, and/or thrust commands. For example, a right inceptor may control roll and pitch and a left inceptor and/or pedal(s) may control yaw and thrust.

Control allocation 1029 may accept as inputs one or more of force and moment commands, data received from the one or more aircraft sensors, envelope protection limits, scheduling parameter, and optimizer parameters. Control allocation 1029 may be configured to determine, based on the inputs, actuator commands by minimizing an objective function that includes one or more primary objectives, such as meeting commanded aircraft forces and moments, and one or more secondary, which can include minimizing acoustic noise and/or optimizing battery pack usage.

In some embodiments, control allocation 1029 may be configured to compute the limits of individual actuator commands based on the actuator states and envelope protection limits. Envelope protection limits may include one or more boundaries that the aircraft should operate within to ensure safe and stable flight. In some embodiments, envelope protection limits may be defined by one or more of speed, altitude, angle of attack, or load factor. For example, envelope protection limits may include one or more bending moments or load constraints. In some embodiments, control allocation 1029 may use envelope protection limits to automatically adjust one or more control surfaces or control settings. Doing so may prevent the aircraft from undesirable scenarios such as stalling or structural strain or failure. In normal operation, the minimum command limit for a given actuator may include the maximum of: the minimum hardware based limit and the minimum flight envelope limit; and the maximum command limit for a given actuator may include the minimum of: the maximum hardware based limit and the maximum flight envelope limit. In the case of an actuator failure, the command limits for the failed actuator correspond to the failure mode.

Control allocation 1029 sends commands to one or more flight elements to control the aircraft. The flight elements will move in accordance with the controlled command. Various sensing systems and associated sensors as part of Vehicle Dynamic Sensing 1031 may detect the movement of the flight elements and/or the dynamics of the aircraft and provide the information to Feedback 1012, 1016, 1018, 1022, Outer Loop allocation 1024 and 1026, Inner Loop Control laws 1028, and Control Allocation 1029 to be incorporated into flight control.

As described above, Vehicle Sensing 1031 may include one or more sensors to detect Vehicle Dynamics 1030. For example, Vehicle Sensing 1031 may capture how the aircraft moves in response to pilot inputs, propulsion system outputs or ambient conditions. Additionally or alternatively, Vehicle Sensing 1031 may detect an error in the aircraft's response based on exogenous disturbances (e.g., gust causing speed disturbance).

Further, Vehicle Sensing 1031 may include one or more sensors to detect propeller speed, such as a magnetic sensor (e.g., Hall effect or inductive sensor) or an optical sensor (e.g., a tachometer) configured to detect the rotor speed of the aircraft engine (and thereby the speed of the propeller). Vehicle Sensing 1031 may include one or more sensors to detect a nacelle tilt angle (e.g., a propeller rotation axis angle between a lift configuration (e.g., FIG. 2) and forward thrust configuration (e.g., FIG. 1)). For example, one or more magnetic sensors (e.g., Hall effect or inductive sensor), position displacement sensors, linear displacement sensors, and/or other sensor(s) associated with the tilt actuator may detect a tilt angle (e.g., relative to the aircraft and/or wing), which may be provided to system 1000. Further, one or more pitot tubes, accelerometers, and/or gyroscopes may detect a pitch angle of the aircraft, which may be provided to system 1000. In some embodiments, Vehicle Sensing 1031 may combine tilt angle sensor measurements and aircraft pitch measurements to determine an overall nacelle tilt angle for the propellers. Vehicle Sensing 1031 may include one or more sensors configured to detect an engine torque and/or thrust, such as one or more current sensors or voltage sensors, strain gauges, load cells, and/or propeller vibration sensors (e.g., accelerometers).

Vehicle Sensing 1031 may include one or more sensors configured to detect Vehicle Dynamics 1030, such as acceleration and/or pitch orientation sensors (e.g., accelerometer(s), 3-axis accelerometer(s), gyroscope(s), and/or 3-axis gyroscope(s), and/or tilt-position sensors to determine angles of engines) and airspeed sensors (e.g., pitot tube sensors). Vehicle Sensing 1031 may further include one or more inertial measurement units (IMUs) to determine an aircraft state based on these measurements. An aircraft state may refer to forces experienced by, an orientation of, a position of (e.g., altitude), and/or movement of, the aircraft. For example, an aircraft state may include at least one of: a position of the aircraft (e.g., a yaw angle, roll angle, pitch angle, and/or any other orientation across one or two axes), velocity of the aircraft, angular rate of the aircraft (e.g., roll, pitch, and/or yaw rate), and/or an acceleration of the aircraft (e.g., longitudinal, lateral and/or vertical acceleration), or any physical characteristic of the aircraft or one of its components. In some embodiments, Vehicle Sensing 1031 may include an inertial navigation system (INS) and/or an air data and/or an attitude heading reference systems (ADAHRS). The inertial navigation systems (INS) and/or an air data and attitude heading reference systems (ADAHRS) may include one or more inertial measurement units (IMUs) and corresponding sensors (e.g., accelerometers, gyroscopes, three-axis gyroscopes, and/or three-axis accelerometers). In some embodiments, the INS and/or ADAHRS may filter and/or otherwise process sensor measurements to determine an aircraft state (e.g., acceleration or angular rate). For example, in some embodiments, the INS and/or ADAHRS may determine angular rates based on gyroscope measurements and may determine acceleration based on measurements from an accelerometer.

As previously discussed, the control margin function may be configured to display a spatial relation between at least one point and at least one reference object. For example, the control margin function, which may be implemented by a computing device (e.g., such as an FCS), may be configured to generate and output a control margin display comprising two reference objects, such as two-dimensional shapes, each shape comprising at least one point associated with the shape. In some embodiments, the reference objects may be polygons. For example, the reference objects may be rectangles, squares, diamonds, hexagons, octagons, or any other polygon. In some embodiments, the reference objects may be closed curvilinear shapes. For example, the reference objects may be ellipses, circles, ovals, or any other closed curvilinear shape. A point associated with a reference object may refer to an external or independent point that is related to the reference object. For example, a point associated with a reference object may include a point within the reference object, a point emphasized on the reference object, a point outside the reference object, or any other representation of a separate point displayed with and related to the reference object. Additionally or alternatively, in some embodiments, the reference objects may include visual representations in more than two dimensions. For example, the control margin display may be configured output or display a three-dimensional shape reference object (e.g., polyhedron, cube, rectangular prism, closed curved surface, sphere, ellipsoid) as a hologram or projection.

In some embodiments, the reference objects may comprise at least one of an inner or an outer reference object. For example, a reference object may be an outer two-dimensional rectangle comprising (e.g., enclosing) an inner two-dimensional rectangle, wherein the outer two-dimensional rectangle may represent an absolute authority limit while the inner two-dimensional rectangle may represent a reduced authority limit determined by the flight control system based on the absolute authority limit. The reduced authority limit may be predetermined and may indicate authority limits within which the aircraft may operate at an optimal or ideal state, a state that is substantially unlikely (e.g., 90%, 99%, 99.99%, etc.) to induce any failure or worsen any existing failures. For example, the reduced authority limit may indicate authority limits within which the aircraft is substantially unlikely to experience PIO. Additionally or alternatively, the reduced authority limit may indicate authority limits within which the aircraft will operate according to one or more preferred flight envelope parameters (e.g., for a smoother flight). In general, the outer reference object may represent an absolute authority limit and the inner reference object may represent a reduced authority limit determined by the flight control system based at least on the absolute authority limit. In embodiments where only one reference object is displayed, it may represent an absolute authority limit or a reduced authority limit, consistent with disclosed embodiments.

In some embodiments, the control margin function may be configured such that a displayed point may move within its respective reference object all the way up to and including (or, in some embodiments, not including) the boundary(s) of the reference object but may not exceed the boundary(s) of the reference object. For example, each point may only move inside its respective shape up to the boundary(s) of the shape. In some embodiments, the control margin function may be configured such that each point may exceed the boundary(s) of the reference object. In some embodiments, the control margin function may be configured to cause a point and/or a boundary to change a displayed appearance based on a proximity between the point and the boundary. For example, the control margin function may be configured such that any points that touch or exceed one or more boundaries of its respective reference object may change color to a predetermined color. Additionally or alternatively, the control margin function may be configured such that any points exceeding or touching the boundaries of its respective reference object may change color from the predetermined color to an original color when the point moves towards the center of its respective rectangle such that the point is no longer exceeding the rectangle or touching any edges. In some embodiments, the point and/or boundary may flash when the proximity between the point and the boundary is determined to be less than a threshold. Further, the control margin function may be configured such that any points exceeding or touching one or more edges of its respective reference object may visually change from an original appearance and may revert to the original appearance when the point is within the boundaries of its respective reference object. For example, a point touching or exceeding an edge of its respective polygon may change from a solid color to a striped pattern, a dotted pattern, may flash, may blink, any combination of the foregoing, or any other visual change different from an original appearance.

In some embodiments, the control margin function may be configured such that one or more shapes may be stationary while one or more points associated with the one or more stationary shapes may move. In some embodiments, the control margin function may be configured such that one or more shapes may move while one or more points associated with the moving one or more shapes may be stationary. Additionally or alternatively, one or more shapes and one or more points may be configured to change shape and/or size. For example, a determined decrease in an aircraft authority limit may correspond with a decreasing in shape or size of the one or more shapes.

According to various embodiments, each reference object may be associated with an inceptor. For example, the control margin display may comprise a left rectangle and a right rectangle which may be associated with a left inceptor and a right inceptor (e.g., joysticks, sticks, controllers, etc.) respectively, relative to the pilot. In some embodiments, each inceptor may be an input device in the form of a stick configured to control movement of an aircraft via manual inputs (e.g., inceptor movements) received from a user (e.g., pilot), which are converted to one or more control signals. In some embodiments, each inceptor may have one or more sensors integrated onto the inceptor configured to respond to a force applied via movement of the inceptor by generating and transmitting electronic signals corresponding to movement of the inceptor to a processor of the flight control system. Additionally or alternatively, each inceptor may comprise a force-feedback component configured to receive control signals from a flight control computer of the flight control apparatus and to apply counter forces based on the received control signals. In some embodiments, at least one of the inceptors may be a passive inceptor. In some embodiments, at least one of the inceptors may be an active inceptor configured to provide haptic feedback. For example, based on (e.g., in response to) determining that an authority has been exhausted, the flight control system may be configured to output haptic feedback via one or both of the inceptors to alert the pilot. “Exhausted” may refer to an authority (e.g., forward thrust, left yaw, right yaw, left roll, right roll, etc.) that cannot be increased, which may be due to a current aircraft state and/or control law (e.g., one or more constraints enforced by the FCS). In some embodiments, a displayed point may indicate a current aircraft state (e.g., relative to authorities indicated by one or more boundaries), Additionally or alternatively, in some embodiments, based on (e.g., in response to) determining that an aircraft state exceeds a predetermined threshold (e.g., an authority or reduced authority limit has been exhausted), the flight control system may be configured to output an alert to the pilot. The predetermined threshold may refer to a limit or value of a commanded authority above which point the aircraft may be operating within or near a hazardous flight condition (e.g., PIO). For example, the flight control system may output a visual alert on a display (e.g., changing colors or flashing displayed material, as disclosed herein), an audio alert, a combination of the foregoing, or any other suitable means of alerting the pilot that captures the pilot's attention.

In some embodiments, corresponding sides of each reference object may correspond to one or more axes of the inceptors. For example, the top and bottom edges (e.g., longitudinal axis) of a left rectangle may correspond to a longitudinal speed axis of the left inceptor, and based on (e.g., in response to) determining that a forward speed authority has been exhausted, the control margin function may cause the control margin display to show a first point of the left rectangle at the top edge of the left rectangle. Additionally or alternatively, based on (e.g., in response to) determining that a backward speed authority has been exhausted, the control margin function may cause the control margin display to show the first point at the bottom edge of the left rectangle. Additionally or alternatively, the left and right edges (e.g., lateral axis) of the left rectangle may correspond to a lateral speed axis of the left inceptor, wherein when the control margin display shows the first point at the right edge of the left rectangle, the control margin function may have determined that a lateral speed authority in the right direction has been exhausted, and wherein when the control margin display shows the first point at the left edge of the left rectangle, the control margin function may have determined that a lateral speed authority in the left direction has been exhausted. Additionally or alternatively, the top and bottom edges of a right rectangle may correspond to a vertical speed axis of the right inceptor, wherein when the control margin display shows a second point of the right rectangle at the top edge of the right rectangle, the control margin function may have determined that a descent rate authority has been exhausted, and wherein when the control margin display shows the second point at the bottom edge of the right rectangle, the control margin function may have determined that a climb rate authority has been exhausted. Additionally or alternatively, the left and right edges of the right rectangle may correspond to a turn-rate authority of the right inceptor, wherein when the control margin display shows the second point at the right edge of the right rectangle, the control margin function may have determined that a turn-rate authority in the right direction has been exhausted, and wherein when the control margin display shows the second point at the left edge of the right rectangle, the control margin function may have determined that a turn-rate authority in the left direction has been exhausted.

Further, in some embodiments, regions of a boundary of a curvilinear shape may correspond to one or more axes of the inceptors. For example, a top quarter and a bottom quarter of a left ellipse's boundary may correspond to a forward and a backward speed authority, respectively. Further, a left quarter and a right quarter of a left ellipse's boundary may correspond to a lateral speed authority in the left and right directions, respectively. Further, a top quarter and a bottom quarter of a right ellipse's boundary may correspond to a climb rate and a descend rate authority, respectively. Further, a left quarter and a right quarter of a right ellipse's boundary may correspond to a left turn-rate authority and a right turn-rate authority, respectively.

In some embodiments, each axis of the inceptors may correspond to one or more edges of each reference object. For example, a longitudinal speed axis of a left inceptor may correspond to four sides of an octagon (e.g., top two and bottom two). In general, it may be understood that each axis of an inceptor may correspond to a similar axis and one or more associated portions of a boundary of a corresponding reference object.

In some embodiments, when the control margin display shows a point at a corner of a reference object, the control margin function may have determined that authorities for 2 axes have been exhausted. For example, when the control margin display shows the second point at the bottom right corner of the right rectangle, the control margin function may have determined that both climb rate authority as well as turn-rate authority in the right direction have been exhausted. In some embodiments, the control margin function may cause the control margin display to display a point in the middle of a reference object, which may indicate that the aircraft is in a state least likely to exhaust any actuation authority limits associated with the reference object. For example, displaying (e.g., by the control margin function instructing the control margin display) a point in the middle of the left rectangle may indicate that the aircraft is in a state least likely to exhaust authorities in the forward speed axis and the lateral speed axis. In some embodiments, a distance between a point and a side or part of a boundary of a reference object may indicate an amount of authority for control limits of the corresponding actuation axis. An actuation axis may represent a dimension or direction (or dual direction) along which a vehicle (e.g., aircraft) can generate control forces. For example, displaying a point near the top side of the left rectangle may indicate less remaining authority in the forward speed axis. In general, the spatial relationship between a point and a portion of a boundary of a reference object corresponds to the available or remaining actuation authority in the corresponding actuation axis.

In some embodiments, the control margin function may be configured to intuitively display actuation limits. For example, the FCS may be configured to translate the input axes of the pilot's inceptors (e.g., four input axes including longitudinal speed axis, lateral speed axis, vertical speed axis, turn-rate axis) into the actuation axes (e.g., actuation axes for longitudinal thrust, vertical thrust, lateral thrust, roll, pitch and/or yaw-rate) of the aircraft. The control margin function may reverse the translation such that aircraft authority limits may be displayed in a format wherein the actuation axes limits are directly correlated to the pilot's inceptor commands, and thus may provide the pilot with context to know how to respond and act accordingly. For example, based on (e.g., in response to) receiving a climb command from one or more pilot inceptors, the control margin function may be configured to determine pitch and thrust limits as well as a proximity of the inceptor commands to the thrust and pitch limits. Based on the determined proximities, the control margin function may be configured to generate a control margin display depicting the determined proximities.

According to various embodiments, the control margin function may be configured to output the control margin display on a portion of a pilot display, such as a primary flight display (PFD). In some embodiments, the control margin display may have a predetermined refresh rate (e.g., 10 Hz, 20 Hz, 30 Hz, or any other frequency), wherein the predetermined refresh rate may be a predetermined percentage of the PFD frequency (e.g., 10%, 20%, 30%, or any other percentage).

In some embodiments, the control margin function may be configured to consider an engine status (e.g., failed, overheating, operating at reduced capacity, etc.) for each engine to determine absolute aircraft authority limits. For example, if one engine has failed, the control margin function may determine that absolute aircraft authority limits may decreased compared to all engines functioning as expected. In some embodiments, the control margin function may be configured to consider envelope protection limits in determining absolute aircraft authority limits. Envelope protection limits may refer to protections within flight control laws to keep an aircraft within predefined limits. For example, envelope protection limits may prevent a pilot from forcing the aircraft into a dangerous state and may alert a pilot if the aircraft is approaching a dangerous state.

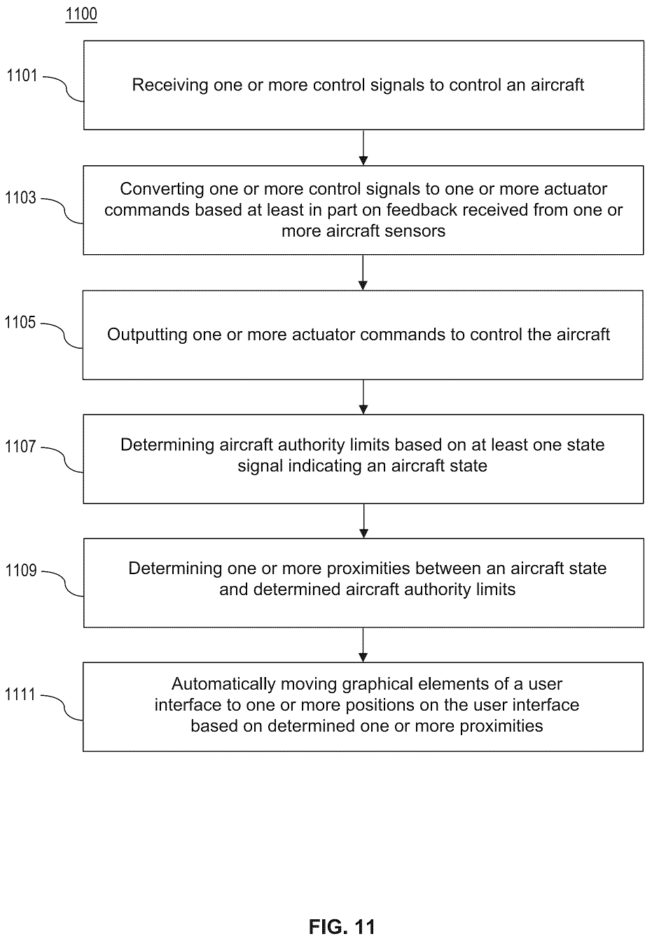

FIG. 11 depicts exemplary method 1100 of determining control margins and outputting a control margin display, consistent with disclosed embodiments. It is appreciated that the steps of the exemplary methods depicted in FIGS. 11-12C would be impossible, or at least impractical, to effectively implement by a human user, especially when considering that these functionalities are implemented frequently (e.g., constantly, continually), while the aircraft is flying (including taking off or landing), and/or dynamically based on (e.g., in response to) received signals (e.g., aircraft sensors, pilot input devices). In general, it may be understood that any/all steps of the exemplary methods of FIGS. 11-12C may be performed or executed by at least one processor (e.g., FCS), such as according to one or more instructions stored on a computer-readable medium (e.g., non-transitory computer-readable medium).

At step 1101, at least one processor (e.g., FCS) may receive one or more control signals to control an aircraft. For example, the processor may receive the one or more control signals (e.g., control inputs) from a pilot input device, such as an inceptor, as described and exemplified with respect to FIG. 10.

At step 1103, at least one processor may convert one or more control signals to one or more actuator commands based at least in part on feedback received from one or more aircraft sensors. For example, the processor may convert the one or more control signals to one or more actuator commands based on feedback received from one or more aircraft sensors, signals from switches, measurements of aircraft state, aircraft mode, actuator state, any combination of the foregoing, or any other suitable data associated with the aircraft. Further, for example, the processor may convert the control signals to one or more actuator commands via one or more of the blocks of system 1000.

At step 1105, at least one processor may output one or more actuator commands to control the aircraft.

At step 1107, at least one processor may determine aircraft authority limits based on at least one state signal indicating an aircraft state. A state signal indicating an aircraft state may include any signal comprising data associated with an aircraft state. For example, the state signal may comprise data including forces experienced by, an orientation of, a position of (e.g., altitude), and/or movement of, the aircraft. Further, in some embodiments, a processor may determine aircraft authority limits based on inverting a control allocation function, an engine status, envelope protection limits, a flight status, one or more actuator commands, any combination of the foregoing, or any other suitable data related to an aircraft.

At step 1109, at least one processor may determine one or more proximities between an aircraft state and determined aircraft authority limits. An aircraft authority limit may refer to an extent to which an aircraft behavior (e.g., trajectory, speed, or combination thereof) obeys (or is capable of or is permitted to obey) a control signal. For example, the processor may determine how close the aircraft state is to an aircraft authority limit (e.g., how much authority in an actuation axis is being used to operate the aircraft in the given aircraft state).

At step 1111, at least one processor may automatically move graphical elements of a user interface to one or more positions on the user interface based on determined one or more proximities. For example, based on (e.g., in response to) determining a proximity between an aircraft state and an aircraft authority limit, the control margin function may automatically command a flight control display to move a point to a location indicating how much authority the aircraft has available relative to an aircraft authority limit).

FIG. 12A depicts an exemplary method of determining control margins and outputting a control margin display, consistent with disclosed embodiments. Steps 1210a, 1212a, 1214a and 1216a comprise exemplary steps, any or all of which are performable (e.g., executable) by the FCS, such as by using a control law algorithm, to transform inceptor commands into actuator commands. Further, one or more steps as depicted in FIGS. 12A-12C may correspond to one or more blocks of system 1000 as depicted in FIG. 10. At step 1210a, the FCS may accept one or more stick inputs, such as a lateral position and/or rate and a longitudinal position and/or rate of both a right inceptor and a left inceptor. At step 1212a, the FCS may map the one or more stick inputs to one or more desired commands (e.g., turn-rate command, lateral speed command, climb command, forward speed command). At step 1214a, the FCS may input the one or more desired commands into a control law algorithm to determine a combination of commands and/or demands to achieve one or more desired forces and compute moment commands. At step 1216a, a control allocation function of the flight control system may receive the determined force and moment commands from the control law algorithm to determine actuator commands.

At step 1218a, the control margin function may initiate a reversal process, wherein the reversal process may comprise reversing steps 1210a to 1216a to determine control margins and output a control margin display. For example, at 1218a, the control margin function may determine achievable force and moment limits by inverting the control allocation function. In some embodiments, inverting the control allocation function may comprise solving one or more optimization problems using achieved forces and moments and actuator limits. Achieved may refer to a force or moment that a processor (e.g., FCS) determines has been executed by the aircraft and any associated actuators. At step 1220a, the control margin function may determine one or more control law limits (e.g., roll limits, pitch limits, yaw-rate limits, longitudinal speed command limit, lateral speed command limit, vertical speed command limit, yaw-rate command limit) by inverting the control law algorithm. At step 1222a and 1224a, the control margin function may invert inceptor mapping by unmerging and reverse mapping the commands to determine stick input limits. At step 1226a, the control margin function may generate and output a control margin display comprising the determined stick input limits by showing the stick input in relation to actuation authority limits on a reference display, such as shown in FIG. 12D.

FIG. 12B depicts an exemplary method of determining control margins for an exemplary control law configuration comprising an outer loop control function and an inner loop control function, consistent with disclosed embodiments. In some embodiments, the FCS (or other computing device) may be configured to perform one or more portions of FIG. 12B. For example, FIG. 12B depicts an exemplary configuration of the steps of FIG. 12A.

At step 1210b, the FCS may accept one or more stick inputs. At step 1212b, the FCS may map the one or more stick inputs to a desired state command, rate command and/or acceleration command. For example, the FCS may map the one or more stick inputs to one or more desired commands (e.g., turn-rate command, lateral speed command, climb command, forward speed command).

At step 1214b, the FCS may input one or more desired commands into a control law of the FCS. For example, the FCS may be configured to input one or more desired commands into an outer loop control function to determine a combination of commands and/or demands to achieve one or more desired forces. In some embodiments, the outer loop control function may comprise an outer loop virtual command function (“oLVirtCmd”), an outer loop feedback function (“OL FB”), an outer loop acceleration function (“OL Accel”), and an outer loop allocation function (“OL Alloc”). In some embodiments, the “oLVirtCmd” function may be a reference model configured to determine an ideal aircraft response and output an acceleration command, rate command, and position command based on the desired commands. In some embodiments, the “OL FB” function may be configured to determine alternative rate commands and acceleration commands to achieve the desired commands based on feedback received from one or more sensors. For example, the outer loop control function may receive vehicle dynamics data, such as position feedback and speed feedback, from one or more sensors. Based on the received sensor data, the “OL FB” function may be configured to determine alternative rate and acceleration commands to achieve the ideal aircraft response. In some embodiments, the “OL Accel” function may be configured to sum the outputs of the “oLVirtCmd” function and the outputs of the “OL FB” function to determine one or more total outer loop acceleration commands (e.g., longitudinal acceleration command, vertical acceleration command, lateral acceleration command) and a total rate command (e.g., turn-rate command). In some embodiments, the “OL Alloc” function may be an optimization algorithm configured to solve a longitudinal/vertical allocation problem and a directional/lateral allocation problem to output “iLCmd.” For example, the “OL Alloc” function may be configured to input a longitudinal acceleration command and a vertical acceleration command into a longitudinal/vertical allocation equation (e.g., u=B⁻¹ χ a) to determine an optimal Fₓ (longitudinal thrust demand), optimal F_{z} (vertical thrust demand), and an optimal pitch command. Additionally, the “OL Alloc” function may be configured to input a lateral acceleration command and a turn-rate command into a directional/lateral allocation equation (e.g., u=B⁻¹×a) to determine optimal roll and yaw-rate commands. In some embodiments, the “iLCmd” function prepares the determined roll, pitch and yaw-rate commands to input into the inner loop control function.

At step 1216b, the FCS may input roll, pitch and yaw-rate commands to an inner loop control function to determine one or more moment commands. In some embodiments, the inner loop control function may comprise an inner loop virtual command function (“iLVirtCmd”), an attitude feedback function (“Att FB”), an inverse plant dynamics function (“Inv Dyn”), a rate feedback function (“Rate FB”), and a sum function. In some embodiments, the “iLVirtCmd” function may be a reference model configured to determine an ideal aircraft response and output an acceleration command, rate command, and angle command based on the received roll, pitch, and yaw-rate commands. In some embodiments, the “Att FB” function may be configured to determine one or more rate and/or acceleration commands based on feedback received from one or more sensors as well as the rate command and angle command received from “iLVirtCmd.” For example, the inner loop control function may receive vehicle dynamics data, such as attitude feedback, from one or more sensors. Based on the received sensor data and the received rate and angle commands, the “Att FB” function may be configured to determine rate and/or acceleration commands to achieve the ideal aircraft response. The “Inv Dyn” function (e.g., moment=inertia χ accel_{cmd}) may be configured to determine one or more feedforward moment commands based on the acceleration command and rate command output by the “iLVirtCmd” function as well as based on the output of “Att FB.” The “Rate FB” function may be configured to determine one or more feedback moment commands based on feedback received from one or more sensors and the rate command and angle command received from “iLVirtCmd.” For example, the inner loop control function may receive attitude rate feedback from one or more sensors. Based on the received sensor data as well as output from “iLVirtCmd” and “Att FB,” the “Rate FB” function may be configured to determine one or more feedback moment commands. The sum function may be configured to sum the outputs of “Inv Dyn,” “Att FB” and “Rate FB” to determine one or more total moment commands. In some embodiments, the sum function may be configured to receive feedforward data from the outer loop control function.

At step 1218b, the FCS may input the determined moment commands and force commands into a control allocation function to determine actuator commands. In some embodiments, the control allocation function may further accept as inputs one or more of data received from one or more aircraft sensors, envelope protection limits, scheduling parameters and optimizer parameters. Based on the inputs, the control allocation function may be configured to determine actuator commands by minimizing an objective function that includes one or more primary objectives, such as meeting commanded aircraft forces and moments, and one or more secondary objectives, such as minimizing acoustic noise and/or optimizing battery pack usage.

At step 1220b, the control margin function may initiate a reversal process, wherein the reversal process may comprise reversing steps 1210b to 1218b to determine control margins and output a control margin display. At step 1220b, the control margin function may invert the control allocation function. For example, the control margin function may be configured to determine achievable force and moment limits based on returned (e.g., achieved) forces, moments, and actuator limits. In some embodiments, the control margin function may be configured to determine achievable force and moment limits by solving a series of linear programming (LP) optimization problems with equality constraints that match the achieved forces and moments of higher priorities. In some embodiments, the control margin function may be configured to determine achievable force and moment limits by solving a series of non-linear programming optimization problems.

At step 1222b, the control margin function may invert the inner loop control function. For example, the control margin function may be configured to input achievable moment limits, feedback and feedforward commands to determine a roll command limit, pitch command limit, and yaw-rate command limit. In some embodiments, the control margin function may be configured to subtract achievable moment limits, feedback, and feedforward commands to determine a feedforward limit. The control margin function may be further configured to invert “Inv Dyn” by using the determined feedforward limit to determine an acceleration command limit (e.g., accelₗᵢₘ=inertia⁻¹×feedforwardₗᵢₘ). Additionally or alternatively, the control margin function may be configured to invert “iLVirtCmd” to determine a roll command limit, pitch command limit, and yaw-rate command limit. In some embodiments, the roll command limit, pitch command limit, and yaw-rate command limit may be determined based on “Att FB” and “Rate FB.”

At step 1224b, the control margin function may invert the outer loop control function. For example, the control margin function may determine command limits (e.g., longitudinal speed command limit, lateral speed command limit, vertical speed command limit, yaw-rate command limit) based on force limits output from inverting the control allocation function and moment limits output from inverting the inner loop control function. For example, inverting the outer loop control function may comprise inverting the “OL Alloc,” “OL Accel” and “oLVirtCmd” functions.

At steps 1226b and 1228b, the control margin function may invert inceptor mapping by unmerging and un-mapping the commands received from inverting the outer loop function to determine stick input limits.

At steps 1230b, the control margin function may generate and output a control margin display comprising the determined stick input limits by showing the stick input in relation to actuation authority limits on a reference display, such as shown in FIG. 12D.

FIG. 12C is a functional block diagram of an exemplary control margin determination method performed by a control margin function of the flight control system, consistent with disclosed embodiments. The control margin function may comprise sub-functions such as Invert Control Allocation 1242, Invert Inner Loop 1244, Invert Outer Loop 1246, Invert Inceptor Mapping 1248, and Control Margin Display 1250. Invert Control Allocation 1242 (corresponding to 1218a and 1220b of FIGS. 12A and 12B, respectively) may be configured to compute force and moment (FM) limits based on actuator limits (e.g., Act. limits) and returned forces and moments (“FM ret”), such as the achieved forces and moments. Invert Inner Loop 1244 (corresponding to 1222a and 1222b of FIGS. 12A and 12B, respectively) may be configured to determine acceleration command limits based on moment limits received from Invert Control Allocation 1242 by computing plant dynamics (e.g., FFₗᵢₘ=Momentₗᵢₘ−FBᵣₐₜₑ−FBₐₜₜ). Invert Inner Loop 1244 may further be configured to determine roll, pitch, and yaw command limits based on the determined acceleration command limits by inverting the inner loop reference model (e.g., iLₗᵢₘ=F(accelₗᵢₘ, rate_{cmd}, state_{cmd})). Invert Outer Loop 1246 (corresponding to 1220a and 1224b of FIGS. 12A and 12B, respectively) may be configured to determine acceleration limits based on force limits received from Invert Control Allocation 1242 and roll, pitch and yaw moments received from Invert Inner Loop 1244 by inverting the outer loop allocation function. Invert Outer Loop 1246 may further be configured to determine command limits, such as a longitudinal speed command limit, lateral speed command limit, vertical speed command limit, and a yaw-rate command limit by inverting the outer loop reference model (e.g., oLₗᵢₘ=F(accelₗᵢₘ, rate_{cmd}, state_{cmd})). Invert Inceptor Mapping 1248 may be configured to unmerge the commands received from Invert Outer Loop 1246 and reverse map the unmerged commands to inceptor limits. Control Margin Display 1250 may compute a ratio of inceptor command versus limits and may generate a display presenting the computed ratio.

FIG. 12D illustrates an exemplary leveraged actuation authority reference display (e.g., control margin display), consistent with disclosed embodiments. In some embodiments, the control margin function may determine or more proximities between an aircraft state and determined aircraft authority limits. A proximity may include a ratio, a fraction, a percentage, or any other representation of a relationship between two values. An aircraft state may be determined based on sensor measurements, responses received from actuators, signals from an input device, any combination of the foregoing, or any other suitable data related to the aircraft. Further an aircraft state may include trim state, speed, altitude, aircraft orientation, attitude, flight path, heading, system status, or any other data related to the aircraft or associated flight plan. In some embodiments, an aircraft state may be influenced or affected by one or more command signals. For example, based on (e.g., in response to) receiving inputs via a left inceptor and/or right inceptor, the control margin function may dynamically determine where the commanded movements are in relation to actuator limits and may display the relationship on a leveraged actuation authority reference display.

An aircraft state may refer to forces experienced by, an orientation of, a position of (e.g., altitude), and/or movement of, the aircraft. For example, an aircraft state may include at least one of: a position of the aircraft (e.g., a yaw angle, roll angle, pitch angle, and/or any other orientation across one or two axes), velocity of the aircraft, angular rate of the aircraft (e.g., roll, pitch, and/or yaw rate), and/or an acceleration of the aircraft (e.g., longitudinal, lateral and/or vertical acceleration), or any physical characteristic of the aircraft or one of its components.

Exemplary control margin displays 1260 and 1262 illustrate each have 2 two-dimensional rectangles, wherein each rectangle corresponds to a pilot inceptor, and wherein each rectangle comprises a point representing a proximity between an aircraft state and determined aircraft authority limits. In control margin display 1260, the points and rectangles indicate that input commands for both the left inceptor (e.g., “LH”) and the right inceptor (e.g., “RH”) are within the actuation authority limits (e.g., rectangles) of the aircraft. The “LH” rectangle indicates that commands received via the left inceptor are approaching authority limits, such as a forward speed authority limit and a lateral speed authority limit in the left direction. In control margin display 1262, the points and rectangles indicate that commands received via the right inceptor are within actuation authority limits, but commands received via the left inceptor have exhausted an authority, such as a forward speed authority. As shown in control margin display 1262, when an authority has been exhausted, the control margin function may move the corresponding point to a corresponding edge of a corresponding rectangle and may change the appearance of the corresponding point.

Additional aspects of the present disclosure may be further described via the following clauses:
1. A method of dynamically moving graphical elements of a user interface of a flight control system, the method comprising:
   determining aircraft authority limits based on at least one state signal indicating an aircraft state, wherein the aircraft authority limits indicate an extent to which one or more control signals can command the aircraft;
   determining one or more proximities between the aircraft state and the determined aircraft authority limits; and automatically moving the graphical elements of the user interface to one or more positions on the user interface based on the determined one or more proximities.
2. The method of clause 1, further comprising:
   receiving, via one or more inceptors, the one or more control signals to control an aircraft;
   converting the one or more control signals to one or more actuator commands based at least in part on feedback received from one or more aircraft sensors; and outputting the one or more actuator commands to control the aircraft.
3. The method of clause 2, wherein converting the one or more control signals comprises: mapping the one or more control signals to one or more desired commands; and inputting the one or more desired commands into a control law algorithm.
4. The method of any one of clauses 1-3, wherein determining the aircraft authority limits is further based on one or more of:
   inverting a control allocation function;
   an engine status;
   envelope protection limits;
   a flight status; and
   one or more actuator commands.
5. The method of clause 4, wherein inverting the control allocation function comprises solving one or more optimization problems based on one or more of:
   achieved forces;
   achieved moments; and
   actuator limits.
6. The method of any one of clauses 1-5, wherein the graphical elements comprise:
   one or more polygons; and
   one or more points associated with the one or more polygons.
7. The method of clause 6, wherein each of the one or more polygons comprise:
   one or more outer polygons; and
   one or more inner polygons within the one or more outer polygons.
8. The method of clause 6 or 7, wherein each side of each of the one or more polygons correspond to control limits of an actuation axis.
9. The method of clause 8, wherein the actuation axis comprises one of:
   a longitudinal thrust axis;
   a vertical thrust axis;
   a lateral thrust axis; and
   a roll-, pitch-, or yaw-rate axis.
10. The method of any one of clauses 6-9, wherein the one or more polygons are rectangles.
11. The method of any one of clause 6-10, wherein the one or more polygons are squares.
12. The method of any one of clauses 6-11, a distance between one of the one or more points and a side of one of the one or more polygons corresponds to an amount of authority for control limits of a corresponding actuation axis.
13. The method of any one of clauses 1-12, wherein the graphical elements comprise:
   one or more closed curvilinear shapes; and
   one or more points associated with the one or more closed curvilinear shapes.
14. The method of clause 13, wherein the one or more closed curvilinear shapes are ovals.
15. The method of clause 13 or 14, wherein the one or more closed curvilinear shapes are circles.
16. The method of any one of clauses 1-15, further comprising:
   outputting an alert to a pilot of the aircraft when the one or more proximities exceed a predetermined threshold.
17. A system for dynamically moving graphical elements of a user interface of a flight control system, comprising:
   at least one processor; and
   at least one non-transitory computer-readable medium containing instructions that, when executed by the at least one processor, causes the at least one processor to perform operations comprising:
      determining aircraft authority limits based on at least one state signal indicating an aircraft state, wherein the aircraft authority limits indicate an extent to which one or more control signals can command the aircraft;
      determining one or more proximities between the aircraft state and the determined aircraft authority limits; and
      automatically moving the graphical elements of the user interface to one or more positions on the user interface based on the determined one or more proximities.
18. The system of clause 17, wherein the operations further comprise:
   receiving, via one or more inceptors, the one or more control signals to control an aircraft;
   converting the one or more control signals to one or more actuator commands based at least in part on feedback received from one or more aircraft sensors; and outputting the one or more actuator commands to control the aircraft.
19. The system of clause 18, wherein converting the one or more control signals comprises: mapping the one or more control signals to one or more desired commands; and inputting the one or more desired commands into a control law algorithm.
20. The system of any one of clauses 17-19, wherein determining the aircraft authority limits is further based on one or more of:
   inverting a control allocation function;
   an engine status;
   envelope protection limits;
   a flight status; and
   one or more actuator commands.
21. The system of clause 20, wherein inverting the control allocation function comprises solving one or more optimization problems based on one or more of:
   achieved forces;
   achieved moments; and
   actuator limits.
22. The system of any one of clauses 17-21, wherein the graphical elements comprise:
   one or more polygons; and
   one or more points associated with the one or more polygons.
23. The system of clause 22, wherein each of the one or more polygons comprise:
   one or more outer polygons; and
   one or more inner polygons within the one or more outer polygons.
24. The system of clause 22 or 23, wherein each side of each of the one or more polygons correspond to control limits of an actuation axis.
25. The system of clause 24, wherein the actuation axis comprises one of:
   a longitudinal thrust axis;
   a vertical thrust axis;
   a lateral thrust axis; and
   a roll-, pitch-, or yaw-rate axis.
26. The system of any one of clauses 22-25, wherein the one or more polygons are rectangles.
27. The system of any one of clauses 22-26, wherein the one or more polygons are squares.
28. The system of any one of clauses 22-27, a distance between one of the one or more points and a side of one of the one or more polygons corresponds to an amount of authority for control limits of a corresponding actuation axis.
29. The system of clause 17-28, wherein the graphical elements comprise:
   one or more closed curvilinear shapes; and
   one or more points associated with the one or more closed curvilinear shapes.
30. The system of clause 29, wherein the one or more closed curvilinear shapes are ovals.
31. The system of clause 29 or 30, wherein the one or more closed curvilinear shapes are circles.
32. The system of any one of clauses 17-31, wherein the operations further comprise:
   outputting an alert to a pilot of the aircraft when the one or more proximities exceed a predetermined threshold.
33. A flight control system for providing information to a pilot via a user interface, comprising:
   at least one processor; and
   at least one non-transitory computer-readable medium containing instructions that, when executed by the at least one processor, causes the at least one processor to perform operations comprising:
      determining aircraft authority limits based on at least one state signal indicating an aircraft state, wherein the aircraft authority limits indicate an extent to which one or more control signals can command the aircraft;
      determining one or more proximities between the aircraft state and the determined aircraft authority limits; and
      automatically moving graphical elements of the user interface to one or more positions on the user interface based on the determined one or more proximities.
34. The flight control system of clause 33, wherein the operations further comprise:
   receiving, via one or more inceptors, the one or more control signals to control an aircraft;
   converting the one or more control signals to one or more actuator commands based at least in part on feedback received from one or more aircraft sensors; and outputting the one or more actuator commands to control the aircraft.
35. The flight control system of clause 34, wherein converting the one or more control signals comprises:
   mapping the one or more control signals to one or more desired commands; and
   inputting the one or more desired commands into a control law algorithm.
36. The flight control system of any one of clauses 33-35, wherein determining the aircraft authority limits is further based on one or more of:
   inverting a control allocation function;
   an engine status;
   envelope protection limits;
   a flight status; and
   one or more actuator commands.
37. The flight control system of clause 36, wherein inverting the control allocation function comprises solving one or more optimization problems based on one or more of:
   achieved forces;
   achieved moments; and
   actuator limits.
38. The flight control system of any one of clauses 33-37, wherein the graphical elements comprise:
   one or more polygons; and
   one or more points associated with the one or more polygons.
39. The flight control system of clause 38, wherein each of the one or more polygons comprise:
   one or more outer polygons; and
   one or more inner polygons within the one or more outer polygons.
40. The flight control system of clause 38 or 39, wherein each side of each of the one or more polygons correspond to control limits of an actuation axis.
41. The flight control system of clause 40, wherein the actuation axis comprises one of:
   a longitudinal thrust axis;
   a vertical thrust axis;
   a lateral thrust axis; and
   a roll-, pitch-, or yaw-rate axis.
42. The flight control system of any one of clauses 38-41, wherein the one or more polygons are rectangles.
43. The flight control system of any one of clauses 38-42, wherein the one or more polygons are squares.
44. The flight control system of any one of clauses 38-43, a distance between one of the one or more points and a side of one of the one or more polygons corresponds to an amount of authority for control limits of a corresponding actuation axis.
45. The flight control system of any one of clauses 33-44, wherein the graphical elements comprise:
   one or more closed curvilinear shapes; and
   one or more points associated with the one or more closed curvilinear shapes.
46. The flight control system of clause 45, wherein the one or more closed curvilinear shapes are ovals.
47. The flight control system of clause 45 or 46, wherein the one or more closed curvilinear shapes are circles.
48. The flight control system of any one of clauses 33-47, wherein the operations further comprise:
   outputting an alert to a pilot of the aircraft when the one or more proximities exceed a predetermined threshold.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent to those skilled in the art from consideration of the specification and practice of the implementations disclosed herein. It is intended that the architectures and circuit arrangements shown in figures are only for illustrative purposes and are not intended to be limited to the specific arrangements and circuit arrangements as described and shown in the figures. It is also intended that the specification and examples be considered as exemplary only, with the true scope and spirit of the invention being indicated by the following claims. The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein. It is also intended that the sequence of steps shown in figures is only for illustrative purposes and is not intended to be limited to any particular sequence of steps. As such, those skilled in the art can appreciate that these steps can be performed in a different order while implementing the same method.

What is claimed is:

1. A method of dynamically moving graphical elements of a user interface of a flight control system, the method comprising:
determining aircraft authority limits based on at least one state signal indicating an aircraft state, wherein the aircraft authority limits indicate an extent to which one or more control signals can command the aircraft;
determining one or more proximities between the aircraft state and the determined aircraft authority limits; and
automatically moving the graphical elements of the user interface to one or more positions on the user interface based on the determined one or more proximities.

2. The method of claim 1, further comprising:
receiving, via one or more inceptors, the one or more control signals to control an aircraft;
converting the one or more control signals to one or more actuator commands based at least in part on feedback received from one or more aircraft sensors; and
outputting the one or more actuator commands to control the aircraft.

3. The method of claim 2, wherein converting the one or more control signals comprises:
mapping the one or more control signals to one or more desired commands; and
inputting the one or more desired commands into a control law algorithm.

4. The method of claim 1, wherein determining the aircraft authority limits is further based on one or more of:
inverting a control allocation function;
an engine status;
envelope protection limits;
a flight status; and
one or more actuator commands.

5. The method of claim 4, wherein inverting the control allocation function comprises solving one or more optimization problems based on one or more of:
achieved forces;
achieved moments; and
actuator limits.

6. The method of claim 1, wherein the graphical elements comprise:
one or more polygons; and
one or more points associated with the one or more polygons.

7. The method of claim 6, wherein each of the one or more polygons comprise:
one or more outer polygons; and
one or more inner polygons within the one or more outer polygons.

8. The method of claim 6, wherein the one or more polygons are rectangles.

9. The method of claim 6, wherein each side of each of the one or more polygons correspond to control limits of an actuation axis.

10. The method of claim 9, wherein the actuation axis comprises one of:
a longitudinal thrust axis;
a vertical thrust axis;
a lateral thrust axis; and
a roll-, pitch-, or yaw-rate axis.

11. The method of claim 6, a distance between one of the one or more points and a side of one of the one or more polygons corresponds to an amount of authority for control limits of a corresponding actuation axis.

12. The method of claim 1, wherein the graphical elements comprise:
one or more closed curvilinear shapes; and
one or more points associated with the one or more closed curvilinear shapes.

13. The method of claim 12, wherein the one or more closed curvilinear shapes are ovals.

14. The method of claim 1, further comprising:
outputting an alert to a pilot of the aircraft when the one or more proximities exceed a predetermined threshold.

15. A system for dynamically moving graphical elements of a user interface of a flight control system, comprising:
at least one processor; and
at least one non-transitory computer-readable medium containing instructions that, when executed by the at least one processor, causes the at least one processor to perform operations comprising:
determining aircraft authority limits based on at least one state signal indicating an aircraft state, wherein the aircraft authority limits indicate an extent to which one or more control signals can command the aircraft;
determining one or more proximities between the aircraft state and the determined aircraft authority limits; and
automatically moving the graphical elements of the user interface to one or more positions on the user interface based on the determined one or more proximities.

16. The system of claim 15, wherein the operations further comprise:
receiving, via one or more inceptors, the one or more control signals to control an aircraft;
converting the one or more control signals to one or more actuator commands based at least in part on feedback received from one or more aircraft sensors; and
outputting the one or more actuator commands to control the aircraft.

17. The system of claim 16, wherein converting the one or more control signals comprises:
mapping the one or more control signals to one or more desired commands; and
inputting the one or more desired commands into a control law algorithm.

18. The system of claim 15, wherein determining the aircraft authority limits is further based on one or more of:
inverting a control allocation function;
an engine status;
envelope protection limits;
a flight status; and
one or more actuator commands.

19. The system of claim 18, wherein inverting the control allocation function comprises solving one or more optimization problems based on one or more of:
achieved forces;
achieved moments; and
actuator limits.

20. The system of claim 15, wherein the graphical elements comprise:
one or more polygons; and
one or more points associated with the one or more polygons.

21. The system of claim 20, wherein each of the one or more polygons comprise:
one or more outer polygons; and
one or more inner polygons within the one or more outer polygons.

22. The system of claim 20, wherein the one or more polygons are rectangles.

23. The system of claim 20, wherein each side of each of the one or more polygons correspond to control limits of an actuation axis.

24. The system of claim 23, wherein the actuation axis comprises one of:
a longitudinal thrust axis;
a vertical thrust axis;
a lateral thrust axis; and
a roll-, pitch-, or yaw-rate axis.

25. The system of claim 20, a distance between one of the one or more points and a side of one of the one or more polygons corresponds to an amount of authority for control limits of a corresponding actuation axis.

26. The system of claim 15, wherein the graphical elements comprise:
one or more closed curvilinear shapes; and
one or more points associated with the one or more closed curvilinear shapes.

27. The system of claim 26, wherein the one or more closed curvilinear shapes are ovals.

28. The system of claim 15, wherein the operations further comprise:
outputting an alert to a pilot of the aircraft when the one or more proximities exceed a predetermined threshold.
